(19) United States
(12) Patent Application Publication
(10) Pub. No.: US 2008/0071579 A1
(43) Pub. Date: Mar. 20, 2008

(54) System For Acquiring and Processing Patient Medical information

(75) Inventors: Diana F. Willson, Durango, CO (US); Lynne E. Valentine, Covington, LA (US); Jennel L. McCoy, Salt Lake City, UT (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/857,625

(22) Filed: Sep. 19, 2007

Related U.S. Application Data
(60) Provisional application No. 60/826,123, filed on Sep. 19, 2006.

(51) Int. Cl. G06F 19/00

(52) U.S. Cl. 705/3

(57) ABSTRACT

A system for processing patient medical information includes a repository of information associating one or groups of predetermined patient medical parameters to be acquired with at least one identifier identifying a medication and a method of administering the medication. A data processor for using the patient medical information links predetermined patient medical parameters to be acquired for a particular patient in association with the at least one identifier identifying a particular medication for administering, and method of administration for the medication associated with the at least one identifier. A user interface provides a display image including data supporting a user in documenting information concerning administration of the particular medication to the patient and enabling the user to view and access an assessment record storing the predetermined patient medical parameters to be acquired in support of the documenting,

This is a non-provisional application of provisional application Ser. No. 60/826,123, filed Sep. 19, 2006, by D. Willson, L. Valentine and J. McCoy.

### FIELD OF THE INVENTION

The present invention relates to healthcare information systems, and more particularly relates to a system for acquiring and processing patient medical information relating to medication administration.

### BACKGROUND OF THE INVENTION

The administration of medications to patients in health care settings typically finds a physician ordering a medication to be administered by a supporting healthcare professional, such as a nurse. Medication administration is a formal process that includes administering the medication and at times making observations during the administration of the medication to a patient, and charting or documenting the observations. That is, while administering the medication per the physician's orders, the nurse or other healthcare professional observes patient medical parameters, and charts the various observations. The observations are stored by the system, and may be recalled to assess the administration and the medication's effects on the patient. Various collections of charted observations supports the workflow of the healthcare personnel charged with making such drug administrations, e.g., nurses.

Electronic medication management systems and healthcare information systems are known. US Patent Application Publication No. 2007/0203755 describes an electronic medication administration information and user interface system that supports a nursing medication management workflow. The disclosed system provides users with display images, which are medical information-bearing windows comprising both a work shift overview of a medication regimen for a particular patient, and an intuitive or “quick view” in a display image or window for documenting a medication administration, and patient medical parameters or observation noticed in furtherance of the administration. The display images are provided by the various windows as forms of a graphical user interface for both displaying the related information, and receiving user input to modify, delete or add to the displayed information.

Within such known electronic medication administration systems, users charged with administering a medication chart observations comprising an assessment in one place, by accessing one electronic function presenting a specific display image, and thereafter further chart the actual medication administration in another place by access to another function and its associated display image. Using such conventional medication management workflow techniques, however, fails to make clear to clinicians reviewing the patient's medication administration record that these two actions or chartings, and the contents of the two (2) recordations are related without considerable review of dates and times.

Such known electronic medication administration systems may further provide for the electronic collection or charting of pre-specified sets of observations relating to a medication administration. Such known pre-specified sets of observations, however, are not specific to or associated with the particular drug or medication ordered, but are associated or created at the time medication is ordered. The use of multiple functions for charting a medication administration and required assessment is more complex and resource intensive where a subset of observations is always available for charting with a particular administration as ordered. Such “subset” observations typically consist of observed patient vital signs of the patient the ordered medication. More importantly, patient medical parameters charted with the medication administration, and any additional related information is not automatically linked for review by a review process or function. Again, the disparate records complicate efforts for global assessment of the administration, and its effect on the patient administered.

In another known system, the specific patient medical parameters to be documented with an administration of a specific medication are not automatically accessible during administration unless first created and linked for the particular medication order. This requires that the facility pre-define and link each necessary flowsheet or observation at the medication order level. Because the link or association with the flowsheet or observation is implemented at the order level, the physician, and therefore the known system must recreate to pre-define, and link same for each order. The added workflow at the ordering level, and the added system load increases with the number or frequency of medications ordered, where a flowsheet or observation is created and linked with the orders. If the physician places a medication order that the facility did not anticipate, and same order would normally require observations with or post administration, a linked or otherwise associated observation or flowsheet record would not exist and a nurse would not be prompted to documents patient medical parameters at the time of administration.

What would be desirable, therefore, in the practice of electronic medication administration, is an electronic medication administration system, process and application program for linking required assessments for a medication administration not for each specific drug order, but by association with a higher system level identification of an identifier for a particular medication, i.e., by its routed drug ID.

### SUMMARY OF THE INVENTION

To that end, the present invention discloses a system and method for processing patient medical information. The system enables a user, preferably an administrative user, to define an observation and/or a flowsheet comprising a group of observations for use with administration and charting medications associated with a specific drug ID. The system allows a physician to order any specific one of the routed medications by simple access to an order function. The system responds by linking the required observation and/or assessment for presentation to the nurse accessing the system at the time of administration and charting for a patient as ordered. The charted observation and/or assessment is automatically presented for subsequent review in association with further administration of the medication to the patient, as well as during review by other system users wishing to access and assess the administration information. The charted observations and assessments are accessible within a context of broader patient assessments. Specific observations and/or assessments associated/linked to a medication administration are viewable with other assessments related to a patient providing a complete overview of patient medical parameters over time. For example, a pain assessment that is charted and associated with a pain medication is viewed with other pain assessments documented for a patient whether the other pain assessments are associated with a medication or not.

By system definition, patient parameters to be observed and charted in association with a specified routed drug ID are created in a form of a single observation in an observation-type assessment, or in a form of a group of observations in a form of a flowsheet for a flowsheet-type assessment. The flowsheet comprises the group or set of observations that are linked by the system in association with the routed drug ID after ordering, and presented when the nurse accesses the system at medication administration. For that matter, for a flowsheet-type assessment, the flowsheet may be linked to one or more routed drug IDs.

While accessing the system to chart a medication administration, a medication administration charting function automatically checks to determine whether a flowsheet or single observation has been created and linked to the medication order in association with the routed drug ID. If an observation and/or flowsheet have been linked to tile medication, the user, e.g., a nurse, attempting to chart or enter data related to the administration is prompted that the assessment should be charted with administration. If the nurse decides to chart the observation or flowsheet after charting the administering, the medication administration display image that prompted to identify the linked observation or flowsheet, by a single key entry automatically presents a display image that displays the observation or flowsheet. The system is constructed to allow data entry via the various system-presented GUI display images using any type of input device available for entering such data, e.g., a keyboard, trackball, mouse, joystick, etc.

This inherent flexibility allows a healthcare facility at which the system is operational to support nursing workflow in following policies and best practice guidelines that define data collection needs for a particular type of drug or medication, and its route or mode of administration. For example, insulin is a medication that requires the observation (evaluation) and documentation of blood glucose levels. As another example, morphine is a medication the administration of which would prompt the nurse to document a pain assessment observation. While the above-mentioned drugs may be administered by various modes, where they are required to be intravenously (IV) administered, display images for a pain assessment (single) observation, as well as other detailed attributes in a flowsheet form or record relating to the IV administration are presented at the time of administration. The more detailed attributes can include an observation or assessment of a physical site of the IV insertion such as a phlebitis score.

By linking a facility-specified flowsheet and/or observation at a routed drug ID level, rather than at an order level, orders created or generated for the same medication with the same-drug or medication identifier have the same flowsheet and/or observation linked at administration and review. The system may subsequently display this collected information for use during and following administration for the same ordered drug. If there is no flowsheet associated with the drug or medication, no flowsheet is displayed. This system operation results in less confusion to users who conventionally would have to determine when flowsheet/observations are to be collected with a particular medication's administration, and whether they are collected at all.

The system stores the observations and assessments collected with a medication administration in association with a routed drug ID in an assessment repository. This allows the assessment information to be readily available for display with other or subsequent chartings whether related to a medication or not. Hence, if a vital sign observation is collected (i.e., charted) and stored with an administration in association with a routed drug ID, this vital sign data is automatically displayed in the correct chronological sequence, as are other charted vital sign observations, which are not necessarily associated with medication administration. A complete view of the patient's vital signs is therefore instantly available as a display image including the recorded drug administration data. For that matter, when a physician or other clinician accesses the system to view the charted assessments linked in association with the routed drug ID, he/she is presented with display images by which it is readily recognized whether there is a flowsheet, or single observation associated, and may choose to view same (if available), for example, a patient medical parameter related to a patient's vital signs.

While system and software application operation of the invention entails a larger network load than a conventional medication administration tracking system, because each pre-defined drug administration order associated with a routed drug ID number has a system-generated associated observation/flowsheet record, and wherein some ad hoc orders would not have the linked observation/flowsheet, the system, method and application software provides a valuable improvement at the practice end in the healthcare facility, which generously counterbalances any increased processing cost.

### BRIEF DESCRIPTION OF THE DRAWING FIGURES

In order that the manner in which the above recited and other advantages of the invention may be obtained, a more particular description of the invention briefly described above is rendered by reference to specific embodiments thereof that are illustrated in the appended drawings. Understanding that these drawings depict typical embodiments of the invention and are not therefore to be considered to be limiting of its scope, the invention is described and explained with additional specificity and detail through use of the accompanying drawings in which:

FIG. 1 is a schematic diagram of a system for processing medical information of the invention;

FIG. 2 is a flow block diagram depicting system process-flow steps executed by the system in one embodiment of the medical information processing system;

FIG. 3 is a display image presented by the medical information processing system for viewing an exemplary IV Assessment associated with a medical patient;

FIG. 4 is a display image presented to allow a user to generate a flowsheet for a flowsheet-type assessment, where the exemplary data defines the flowsheet for the IV Assessment designated in the FIG. 3 display image;

FIGS. 5 and 6 depict display images presented that allow the user to create a specific observation for the flowsheet;

FIG. 7 is a “drug selection” display image presented to the user when they select a medication for which the system links a flowsheet or single observation in association with a routed drug ID for use in charting the medication administration;

FIG. 8 is a “drug detail” display image presented for the user to view and modify details for a particular routed drug ID that is linked at charting;

FIG. 9 is an “assessment detail” display image presented to a user where no assessments are linked via the routed drug ID after actuating a feature presented by the drug detail display image depicted by FIG. 8;

FIG. 10 is an “assessment detail” display image presented to a user when a routed drug ID is linked to a flowsheet mnemonic, for example, FVASSESS in the exemplary display image;

FIG. 11 is a display image that is presented where an assessment flowsheet was previously linked to a routed drug ID, after a user selects a flowsheet in the display image presented as FIG. 8;

FIG. 12 is an “administration detail” display image presented to a user for charting an administration for the medication in the drug detail display image depicted by FIG. 8, highlighting that the medication administration information can be linked to an IV Assessment;

FIG. 13 is a display image presented that allows the user to chart the observations comprising the linked flowsheet relating to the TV assessment, where the user has opted to complete an assessment immediately after charting;

FIG. 14 is an “administration detail” display image for a charted medication administration such as depicted in the FIG. 12 display image where the IV Assessment is displayed as a hyperlink;

FIG. 15 is an “assessment detail” display image presented by the system when a user accesses the details of the exemplary IV assessment that is linked to the medication administration detail display image depicted by FIG. 14;

FIG. 16 is an “administration history” display image highlighting for a user that administration of the medication identified is linked to an IV assessment flowsheet;

FIG. 17 is an “observation editing” display image presented to a user when entering details for a single linked observation for a painscale assessment, similar in structure to the display image depicted by FIG. 5;

FIG. 18A is a “drug detail” display image, similar in structure to the display image depicted by FIG. 8, but where the linked medication or routed drug ID is identified by the system designation: Tylenol1;

FIG. 18B is a single observation display image presented to link an observation as distinguished from a flowsheet in associated with a routed drug ID or identifier;

FIG. 19 is a “medication administration detail” display image presented for documenting a medication with a painscale observation linked by system operation in association with Tylenol1;

FIGS. 20 and 21 are “medication administration history” display images that are presented to highlight a linked painscale observation (FIG. 20) and a linked assessment (FIG. 21), respectively;

FIG. 22 is a flow block diagram depicting system process-flow steps executed by the system in another embodiment of the invention;

FIG. 23 depicts a portion of the “drug detail” display image presented by FIG. 8, where the routed drug ID is Extra strength Tylenol, to be administered orally at 500 mg;

FIG. 24 depicts a portion of the “assessment selection” display image presented by FIG. 11;

FIG. 25 depicts a portion of an exemplary medication administration display image that identifies three different medication orders for Tylenol by same drug ID;

FIG. 26 depicts an exemplary “order select” display image presented to a physician when using the system to order a medication by routed drug ID;

FIG. 27 is a portion of an exemplary medication administration record (MAR) display image presented to a nurse when accessing the system and an order has been entered requiring him/her to administer the medication to the patient (order);

FIG. 28 depicts an exemplary “medication administration detail” display image for charting a medication administration (Tylenol, 500 mg.), and that an observation or flowsheet is linked in association with the routed drug ID;

FIG. 29 depicts a display image presented to the nurse to document a full pain assessment (flowsheet) by activation of a “Chart” button presented with the display screen of FIG. 28;

FIG. 30 depicts a display image that presents a full pain assessment that is linked to a specific medication administration;

FIG. 31 depicts a “medication administration detail” display image highlighting a view of all flowsheets for a patient including a Pain Assessment flowsheet linked in association with a routed drug ID by the system during medication administration including those non-medication related;

FIG. 32 depicts a “pain assessment” display image presenting pain assessments for a patient comprising the pain assessment flowsheet identified in the flowsheet view depicted by FIG. 31;

FIG. 33 is a system block diagram of another embodiment of the invention; and

FIG. 34 is an exemplary processing unit comprising an interface of FIG. 33.

### DETAILED DESCRIPTION OF THE INVENTION

A system for processing patient medical information is described and set forth herein for the purpose of conveying broad inventive concepts of the system operation. The drawings and descriptions provided are not meant to limit the scope and spirit of the invention in any way.

The process of medication administration is complex, and involves important responsibilities that nurses or other medical practitioners carry out to administer a physician medication orders, including what is observed and charted in addition to charting the physical administration of the ordered medication. The amount of information entered into an electronic medication administration system related to medication administration, including nursing observations and clinical assessments associated with a patient's medication regimen can be enormous. Consequently, it is desirable from a patient-safety standpoint that a nurse or other medical practitioners administering a medication have an efficient, effective and detailed system to support medication administration workflow.

The system advantageously provides for linking forms for collecting medication administration information to a universal routed drug ID (identifier) so that in ordering a medication for a patient, a physician or other healthcare professional charged with such administering need not manually “build” or define such a form each time he/she accesses the system to input an order, nor is the facility required to pre-link such assessments in association with each medication order. Medication assessments in a form of an observation-type and flowsheet type assessments are preconfigured for specific medications having specific routes, and identified by routed drug ID prior to medication administration processing by the system.

The physician selects a medication for ordering; the order is identified for system operation with a system operational level that is more global, in association with the routed drug ID medication identifier, than a medication ordering level of system operation. The linking of any required observation or set of observations in a form of a flowsheet is automatically carried out by the system in association with the drug ID, and the prior universal configuring. Both the flowsheet-type and single observation assessment display images presented (if linked) during system medication administration operation, at a charting part and at a review part of the operation. In the charting part of the system operation, the display images presented to the nurse for administering a medication automatically identify whether an assessment and/or observation is required or suggested in addition to charting the physical administration.

A medication administration display image is presented to a nurse preparing to document the administration of an ordered medication. If the routed drug ID identifier for ordered medication was previously linked to an observation and/or flowsheet, any observations or groups of observations (flowsheets) suggested to be charted with the medication administration will be displayed for the nurse. The nurse may click on the presented buttons or otherwise navigate to other display images to input, modify and review any required observation information.

The system-defined assessment definitions linked in association with a routed drug ID, as well as information charted in a form of the linked observations are stored in a central storage repository maintained by the system for that purpose. As used herein, the terms drug and medication are interchangeable. The observations or patient medical parameters are linked automatically by the system for administration and review in association with the “routed drug ID.” The linking provides a significant improvement to facility configuration, physician ordering and nurse administration of medications (e.g., workflow) in accordance by system operation associated with the routed drug IDs. And linking improves efficiency and capability for tracking the effects of the medication on the patient through time, or the effects of a medication's use globally by accessing information associated with the routed drug ID.

Routed drug ID as used herein is a unique identifier for a specific drug or medication, including its specified route or method of administration that is stored in a medication master file. The reader should note that the terms “medication” and “drug” are used interchangeably herein. Routing is a process by which a drug is administered. The system associates a medication and specified route with unique identifiers such as a drug identification number. The routed drug ID is utilized by the system to link together the same drug or medication orders, at the generic level, with the specified route or method of administration, e.g., oral intra-venous infusion, injected, external (skin) application etc. For example: Amoxicillin oral. Drugs or medications that would be included for this routed drug ID number include: Amoxicillin (TRIMOX) oral 250 mg capsule; Amoxicillin (TRIMOX) oral 500 mg capsule; Amoxicillin (AMOXIL) oral 250 mg capsule; Amoxicillin (AMOXIL) oral 500 mg capsule; and Amoxicillin (AMOXIL) oral 125 mg/5ml suspension. The above medications would belong to the same routed drug ID. And as mentioned, system operation includes generating and maintaining a medication master file for storing the routed drug IDs, and associated information.

When a single observation or patient parameters is collected during administration of a medication associated with a routed drug ID, the system provides an ability to link the specific observation for display by a single display image customized for the particular medication being administered by its particular route or mode of administration. Display image as used herein refers to the various display images or display windows presented during system operation to enables users to use and interact, or interface with the system. The user may view, and input and modify the medication-related information by use of the display images.

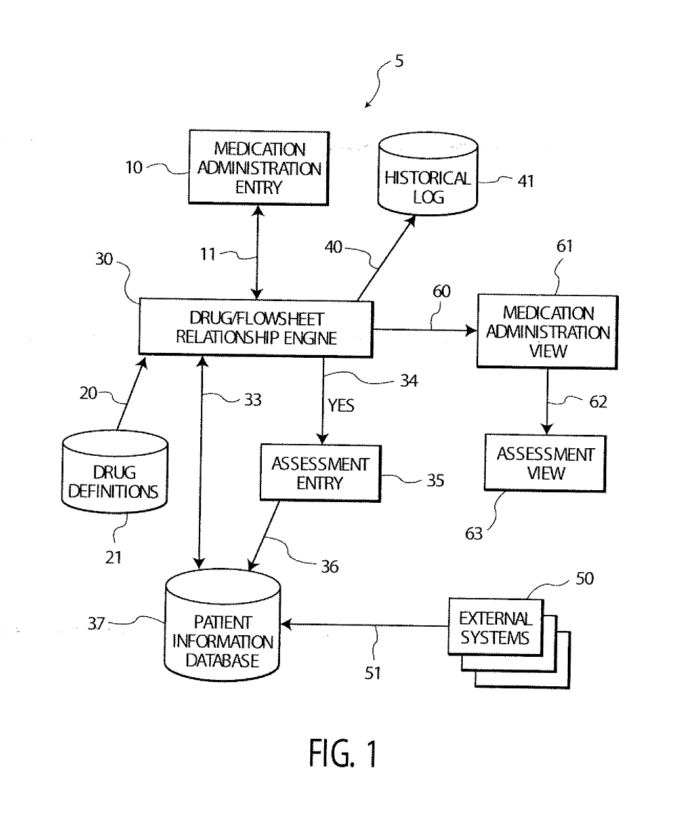

One embodiment of the invention is described below with reference to a system (5) for processing medical information, including medication administration shown in FIG. 1. System (5) provides a healthcare facility with ability to universally link flowsheet-type or observation-type assessment requirements at a facility level prior to an intended medication administration operation by association with a routed drug ID. When a physician orders a medication for a patient during intended system operation, the suggested assessment data to be charted by the nurse with and pursuant to its administration are automatically presented. The system's medication administration process uses the pre-definition of assessments, and their required observations to tailor the system's collection of medication-related information, and access to display images.

The medication information associated with system-defined routed drug IDs is defined by and maintained by the system (5) in a drug definitions file or repository (21). Drug definitions repository (21) is accessible by an interface (20) via a drug/flowsheet relationship engine (30). A medication administration entry (10) is displayed to the user and communicates with the drug/flowsheet relationship engine (30) using an interface (11). Drug/flowsheet relationship engine (30) determines whether there is a drug/flowsheet relationship to display to the user, and retrieves the information linked by the relationship from a drug definitions file or repository (21) using interface (20).

During system operation, when a medication administration entry (10) is saved using interface (11), the drug/flowsheet relationship engine (30) determines if the user has opted to chart an assessment with a particular medication administration. If the user opts not to chart an assessment, that information is written to a patient information database (37) using an interface (33). If the user does opt to chart an assessment with this medication administration, an assessment entry (35) for a predetermined flowsheet, including a set of patient parameters, or a single observation in a single observation form is presented to the user using an interface (34) based on at least one identifier, or routed drug ID for the medication. When an assessment entry is saved by the system, the patient medical parameters or observations comprising the assessment are written to a patient information database (37) using interface (36), and automatically linked by association with the at least one identifier or routed drug ID.

The drug/flowsheet relationship engine (30) determines which flowsheet (if any), and which single observation assessment form (if any), to make available from the medication administration view (61) to the user using interface (60). The drug/flowsheet relationship engine (30) makes the determination by communicating with the patient information database (37) using interface (33). The user can access a flowsheet or assessment view (63), or a single observation view, which is presented using interface (62). External systems (50) may also interact with the patient information database using interlace (51). A historical log (41) keeps track of related interactions with the system using interface (40), e.g., a medication administration history function.

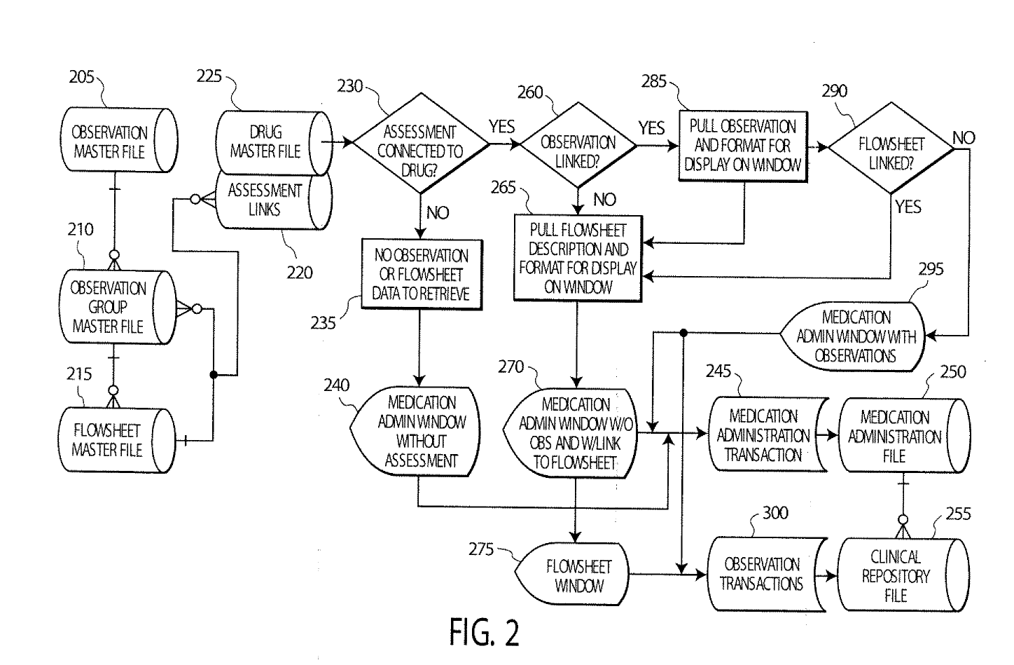

System operation is described in further detail with respect to a system flow diagram depicted in FIG. 2. The reader and skilled artisan should readily note that the system process is implemented as an executable application for processing patient medical information including medication administration on any computer system programmed to do so. An executable application as used herein comprises code or machine readable instructions, which when compiled or interpreted to implement predetermined functions including those of an operating system, healthcare information system or other information processing system, for example, in response user commands or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein as a device and/or set of machine-readable instructions for performing tasks.

A processor comprises any one or combination of, hardware, firmware, and/or software. A processor acts upon information by manipulating, analyzing, modifying, converting or transmitting information for use by an executable procedure or an information device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device and associated data acquisition and processing functions.

The FIG. 2 system flow depicts operation for associating assessments with a medication administration, so the nurse charting the administration knows whether or not to chart particular with administration, or pursuant to administration. As already mentioned, the assessment links are presented in the display images provided for charting the administration associated with the routed drug ID. And as already mentioned, the flowsheet or observation definition for a routed drug ID is first defined and linkably stored prior to intended system operation. In this building part of the system flow, the suggested or required assessment observations (or predetermined patient medical parameters) to be collected with medication are selected or defined and stored in an observation master file (205). The reader should note that “patient medical parameters” and “observations” are used herein to convey the same meaning.

Defined groups of observations are stored in an observation group master file (210). Flowsheets for a flowsheet-type assessment are stored in a flowsheet master file (215). The observation master file (205), observation group master file (215) and the flowsheet master file (210) store the set up for required assessment charting with administration charting in association with a routed drug ID. The set up or definition is linked in the form of the flowsheet, as described above, at the medication ordering and/or medication administration charting.

Assessment links file (220) stores assessment links to any of the stored flowsheets or single observation assessment forms. Drug master file (225) stores functional information for a particular medication or drug, including its routed drug ID or identifier. If it is determined (230) that an assessment has not yet been linked to the medication (in association with its routed ID), the system flow branches to functional block (235), representing a function that identifies that there are no observations or flowsheet data to retrieve for the assessment. Where no single observation form or flowsheet is defined to be linked to an assessment, the system displays a medication administration display image or window, as represented by functional block (240). System operation by which a medication administration display image is defined as a medication administration transaction is depicted by functional block (245). To carry out such a medication administration transaction, the system accesses a medication administration file or repository (250). The medication administration file has access to a clinical repository file (255) as shown.

If system operation represented by decision diamond (230) determines that an assessment is linked to a specific medication, the system determines whether assessments in a form of individual observations are associated with the routed drug ID linked assessment. This system operation is represented by decision diamond (260). There, the system determines whether any observations are linked to the assessment. If no individual observations are associated with the routed drug ID linked assessment, system flow progresses to a function represented by functional block (265). There, the flowsheet description is accessed and formatted for display. The system flow progresses to a function represented by functional block (270). By use of this function, the system displays the formatted medication administration display image identifying that the assessment is either linked, or is not linked to a single observation.

System flow advances to the medication administration transaction, represented by functional block (245). By use of this function, the system displays the routed drug ID assessment information for drug-related assessments with or without a single observation presented. The system function represented by functional block (275), upon the required user input, presents a flowsheet display image where flowsheet information is linked, as represented by block (275), discussed in greater detail with respect to functional block (285) below. Functional block (300) represents a system function whereby particular observations linked as a flowsheet or single observation form can be presented.

Where system functioning or operation represented by decision diamond (260) finds that single observations are linked to an assessment linked in association by a routed drug ID, the observation is accessed and formatted for presentation as a display image by system operation represented by functional block (285). The system determines whether a flowsheet, as distinguished from a single observation, is linked to an assessment associated with a routed drug ID. Decision diamond (290) represents the system function that determines whether a flowsheet is linked. If a flowsheet is linked, system flow proceeds to a system function represented by functional block (265), as described above. But where the system determines that no flowsheet needs to be linked, a medication administration display image is presented indicating that no flowsheet is linked. This function is represented by functional block (295), whereafter system flow proceeds to the function represented by blocks (245) and (300).

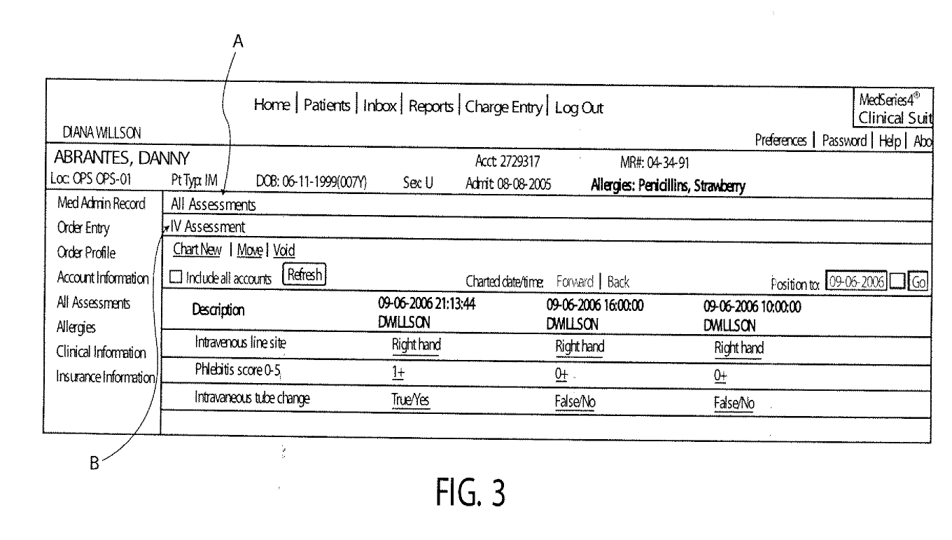

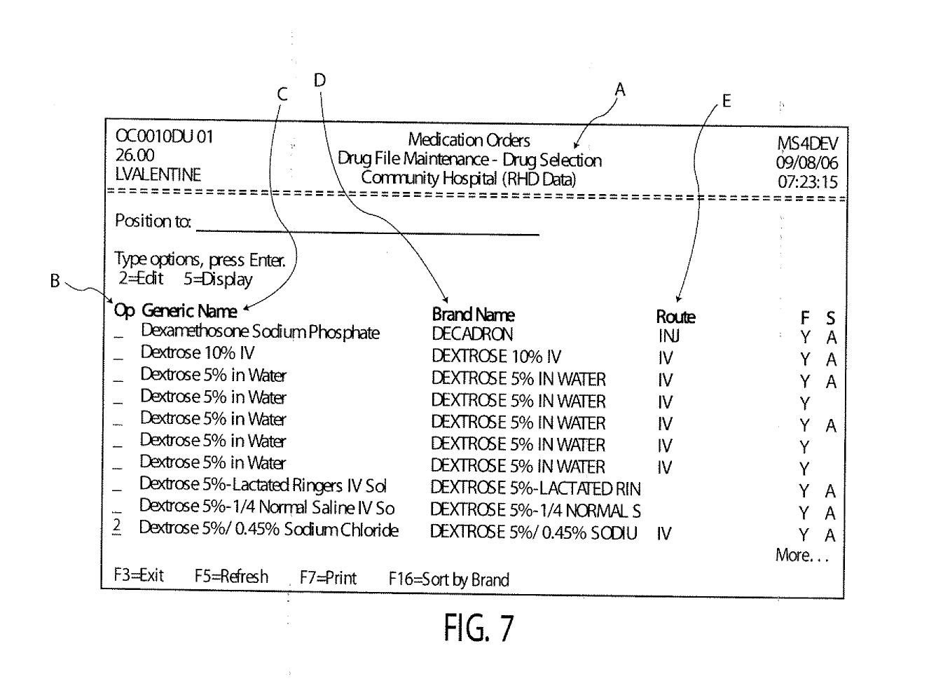

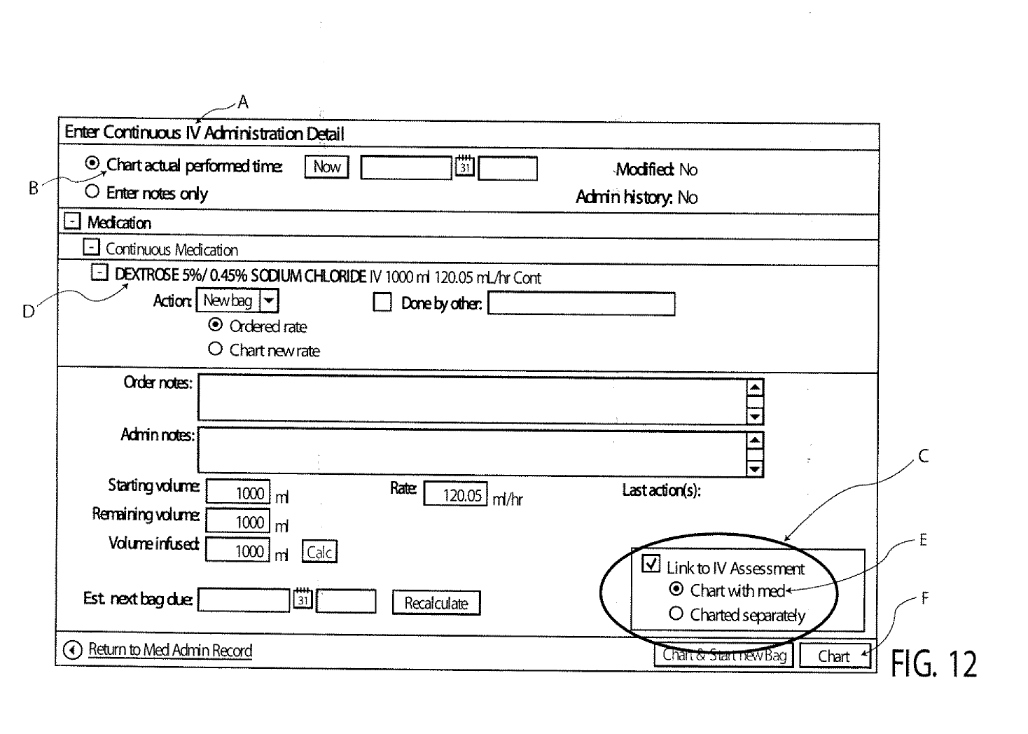

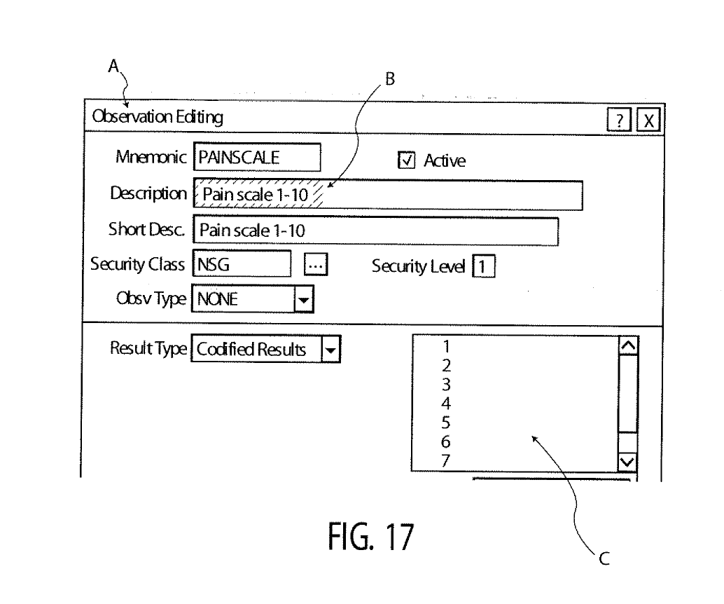

The various display images that generated and presented during medication administration system flow are now described with respect to FIGS. 3-21 and 23-32 herein. As an aid in understanding the detailed system operation, the system flow is described as various parts of the system-implemented medication administration process. A first part, or “assessment building” part, references display images or windows depicted by FIGS. 3-6. A next part, “connecting a flowsheet to a routed drug ID,” is described in association with the display images or windows depicted by FIGS. 7-11. A next part, “collecting a flowsheet assessment while charting medication administration,” is described in association with the display images or windows depicted by FIGS. 12-16. And a next part, “connecting an observation to a routed drug ID,” is described in association with the display images or windows depicted by FIGS. 17-19.

Assessment Building

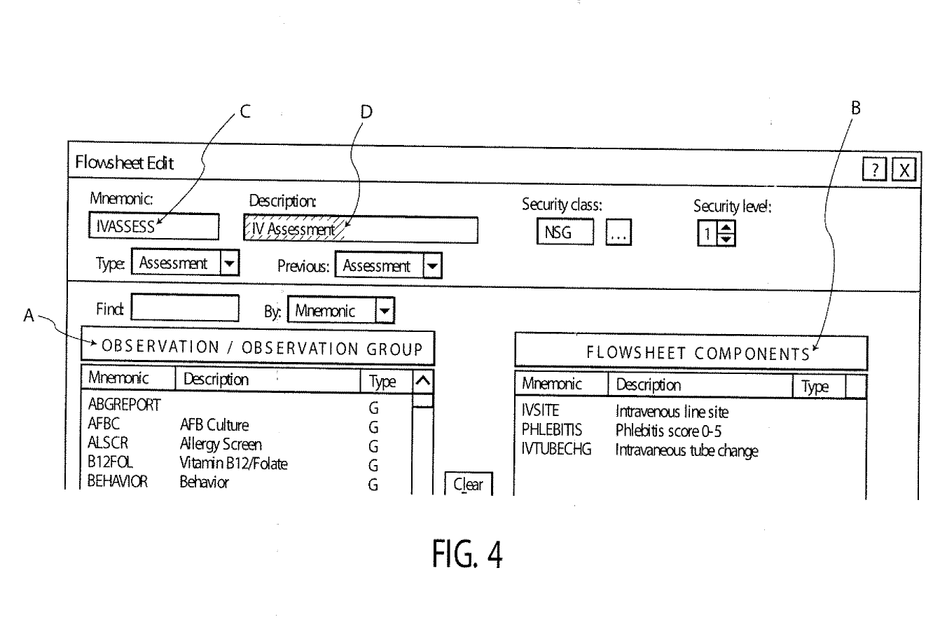

In the assessment building part, observations, or predetermined patient medical parameters are created and accessibly stored in observation master file (205), as described above with respect to FIG. 2. A display image depicted by FIG. 3 is generated and presented by the system for viewing “All assessments” for a particular patient, designated by arrow A. As can be seen, the “all assessments” catalog includes an exemplary “IV Assessment” entry, designated by arrow B. Information or data comprising the IV assessment, including any predetermined required observations, may be accessed by the user choosing or activating the IV Assessment tab or button as shown. FIG. 4 depicts a display image or window for presentation to a user to interactively identify and link observations for grouping-in a flowsheet and other flowsheet components for the IV assessment depicted by FIG. 3.

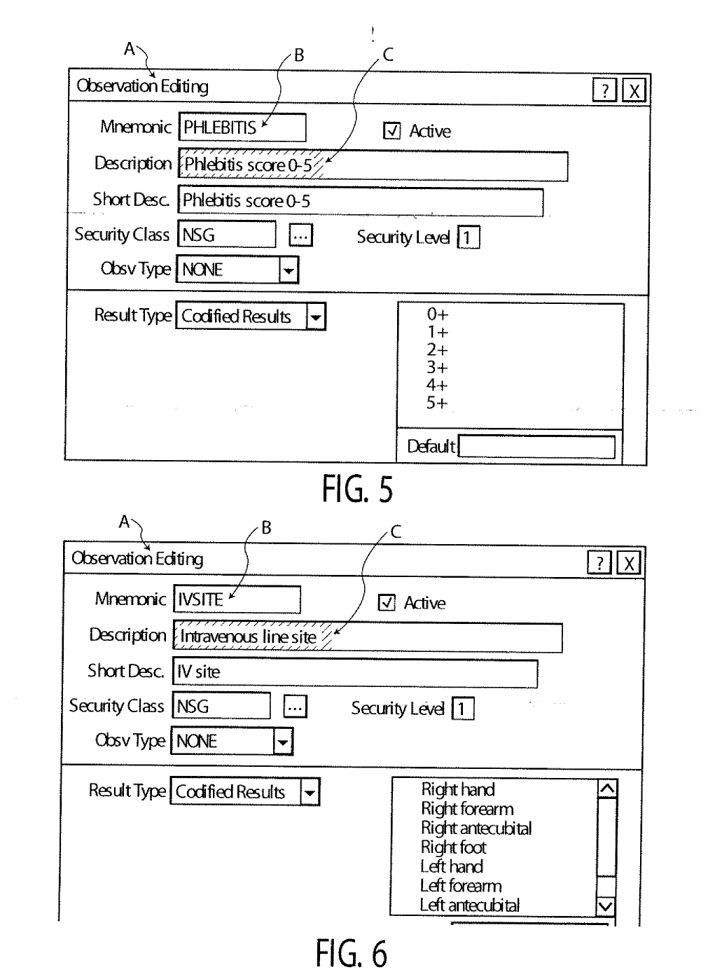

FIGS. 4 is a display image generated and presented to allow a user to define or modify individual observations, or group (set) of observations (arrow A) to be linked in an observation form, or in a flowsheet form for a flowsheet-type assessment (arrow B). Arrow C points to a mnemonic IVASSESS, and arrow D points to description IV Assessment, with particular patient medical parameters attributed to the flowsheet or observation listed. Exemplary FIGS. 5 and 6 present “Observation Editing” display images (arrow A in both figures) highlighting a PHLEBITUS observation (arrow B, FIG. 5) requiring a “Phlebitis score 0-5” input (arrow C of FIG. 5), and IVSITE observation (arrow B of FIG. 6) requiring an “intravenous line site” observation (arrow C in FIG. 6).

Connecting a Flowsheet to a Routed Drug ID

At a configuration level of system medication administration, an authorized user selects a medication to have a linked observation or set of patient medical parameters in flowsheet form by association with the medication routed drug ID or identifier. Such system operation precedes ordering and administration of the medication. At ordering, a physician creates a medication order by selecting a medication by drug ID. If the medication order (by routed drug ID) has a linked flowsheet or observation, the flowsheet and/or observation is presented to the nurse at administration.

FIG. 7 presents a medication selection display image displayed to allow input of medication ordering information to both create a link to a flowsheet and/or observation at a system administration level, and at a system ordering level. Exemplary FIG. 7 “drug selection” display image (arrow A) is controlled to receive a “2” from a user, entered in an “Op” column for a chosen medication (arrow B), identified by generic name (arrow C), brand none (arrow D) and route (arrow E), as shown. A medication order is completed when the user provides an input: <ENTER>, using a traditional keyboard. The invention, however, is not limited to a keyboard for user entry of data, but may be accomplished using a data entry means known and available to the skilled artisan without deviating from the scope and spirit of the invention.

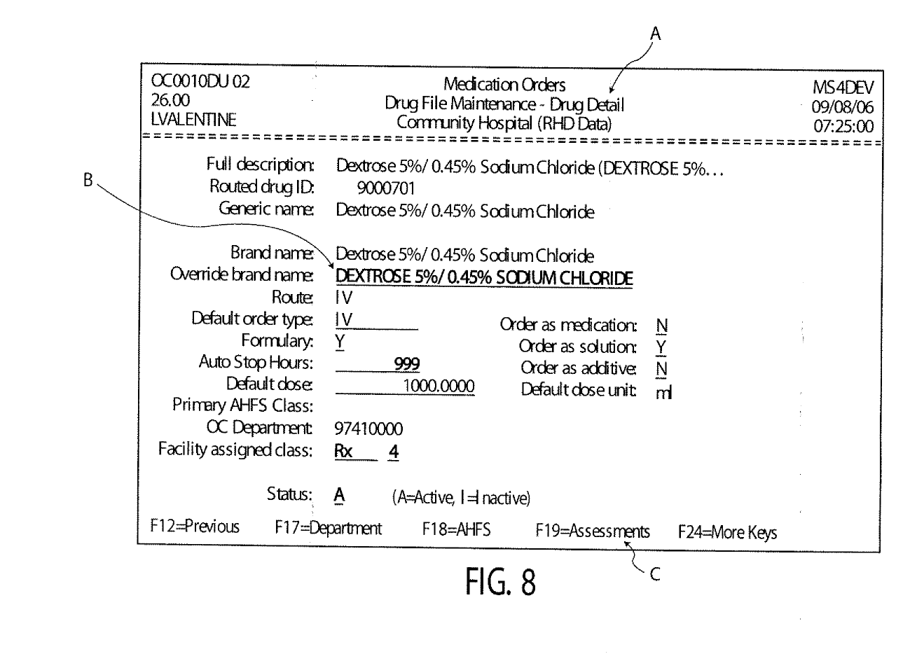

The authorized user selects a medication to set up a flowsheet or observation by routed drug ID, such as those listed in the FIG. 7 drug selection display image. The system navigates to a “Drug Detail” display image depicted by FIG. 8. The FIG. 8 drug detail display image presents the ordering details required to configure system operation so flowsheet or observations are automatically linked at medication ordering by routed drug ID. In this example, the drug detail window displays the medication selected by the physician using the FIG. 7 drug selection window, i.e., Dextrose 5% /0.45% sodium chloride (identified by arrow B). The user navigates the display image to determine whether assessments are required to be linked according to the ordered drug ID definition. This function is executed when the physician presses a predetermined key using a key input device <F]9> (arrow C).

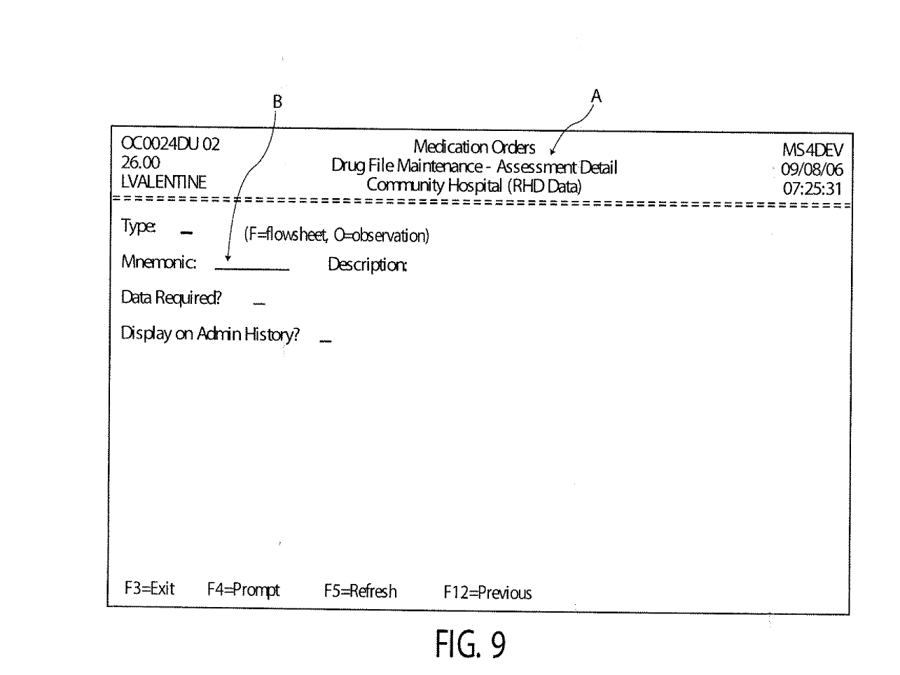

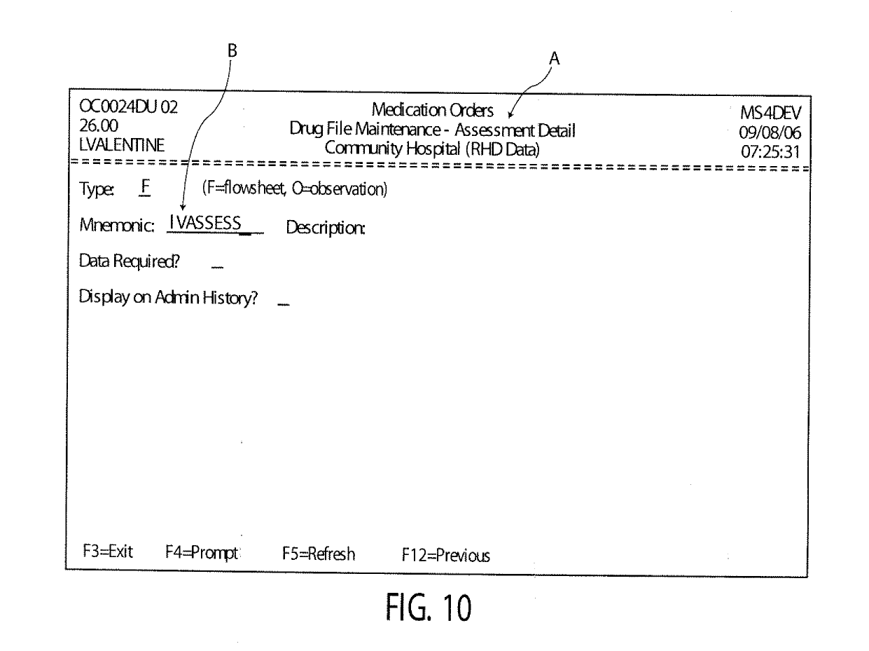

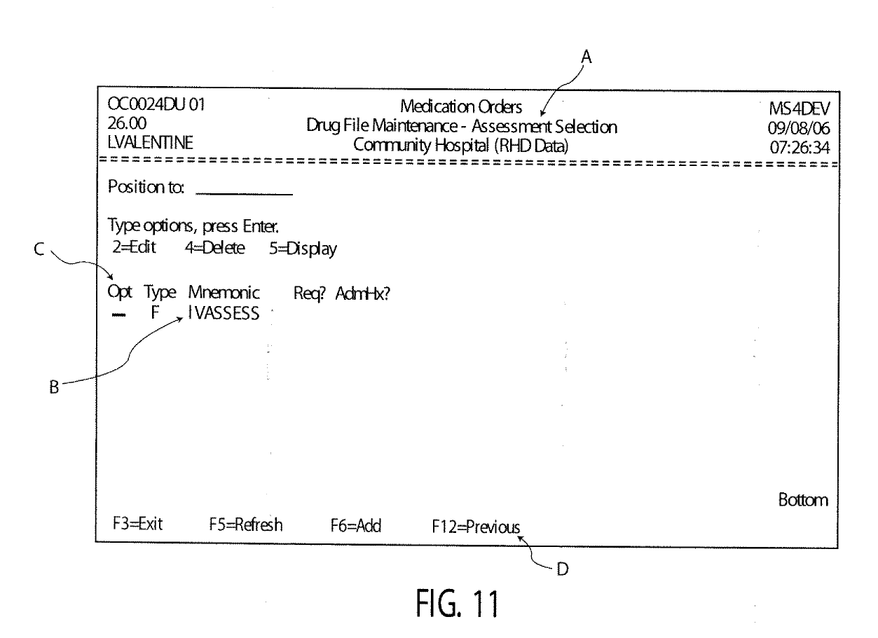

If no assessment is linked to the selected medication (flowsheet-type or single observation-type) at this place in the process flow, the system automatically presents the user with an “assessment detail” display image, as depicted by FIG. 9. The assessment detail (arrow A) display image allows a user to specify a mnemonic (arrow B) for a flowsheet-type assessment to link to the medication record. The display image allows the user to define whether an observation and/or flowsheet is linked for documenting during a process of charting a medication administration for the routed drug ID. Thereafter, access to system-stored details associated with the routed drug ID or identifier immediately identifies (or prompts) as to whether a flowsheet-type assessment or observation is linked to the routed drug ID.

Where the system determines that one or more assessments have previously been linked for the medication being ordered, an “assessment selection” display image is presented as shown in FIG. 11. The assessment selection window (arrow A) allows the ordering physician to select an assessment, IVASSESS (arrow B). As mentioned, once selected and completed, the system links the assessment for presentation to a nurse accessing the medication administration record to administer the ordered medication. By such operation, the nurse readily sees that an assessment should be, or has been charted for the ordered medication identifier (routed drug ID).

Where the authorized user wishes to modify the definition of an assessment that has already been linked to the routed drug ID definition, she/he inputs or types a “2” in the “Opt” column (identified by arrow C), and an <ENTER> key. In response, the system presents the user with an assessment detail display image as shown in FIG. 10 (arrow A) In the exemplary embodiment, the assessment is identified as IVASSESS (arrow B). By use of the FIG. 10 assessment detail display image as shown, the authorize user can link a new assessment by pressing another predefined key or input, e.g., <RF6>. In response, a new assessment detail window such as shown in FIG. 9 is displayed. Using the window or window, the user may define the properties for the assessment. The assessment details fields, which are set by the physician for the assessment, are defined in detail by Table 1.

TABLE 1

| Field | Data Entered | Function/Additional Information |
|---|---|---|
| Type | Type F, O | Indicates whether the assessment is |
| | | a Flowsheet, or Observation-type |
| | | Assessment. |
| Mnemonic | type a valid mnemonic | When you press F4, the list of |
| | or press <F4> to select | valid mnemonics contains |
| | a mnemonic from a list | flowsheets or observations, |
| | of valid values. | depending on the value |
| | | selected by a user for |
| | | the Type field. |
| Description | | This is a display-only field that |
| | | contains the Description associated |
| | | with the selected |
| | | Mnemonic |

| | |
|---|---|
| Data | For future use with assessments. |
| Required? | |
| Display on | For future use with assessments. |
| Admin | |
| History? | |

Entering a valid mnemonic may be done by manually spelling it out or by pressing a special key, e.g., a key <F4>, in the assessment detail display image of FIG. 11. By inputting an F or an O, the user defines whether an assessment is a flowsheet-type assessment, or a single observation-type assessment. The system allows the authorized user to link both single observation assessments and flowsheet-type assessments comprising a group of observations with a routed drug ID order.

The description field is a display-only field containing an assessment mnemonic's description. The “data required?” and “display on admin history?” fields are reserved for future use, such as for maintaining required regulatory information that could be required for tracking with a particular medication and its administrative route, or drug ID. These fields allow the authorized user to select that an observation and/or flowsheet is required, or not, and to display the related information in administration history display images. After entering the data defining or modifying an assessment, the user activates an <ENTER> key, to apply the desired changes. Preferably, the system requires the user to confirm the changes when prompted. Thereafter, the drug detail display image or window of FIG. 8 is again presented to the user. Alternatively, the user may press a pre-selected key, e.g., <F12> for “previous” display image (as designated by arrow D), where the system responds by presenting the previous FIG. 8 drug detail display image without applying changes.

Collecting the Flowsheet Assessment While Charting Medication Administration.

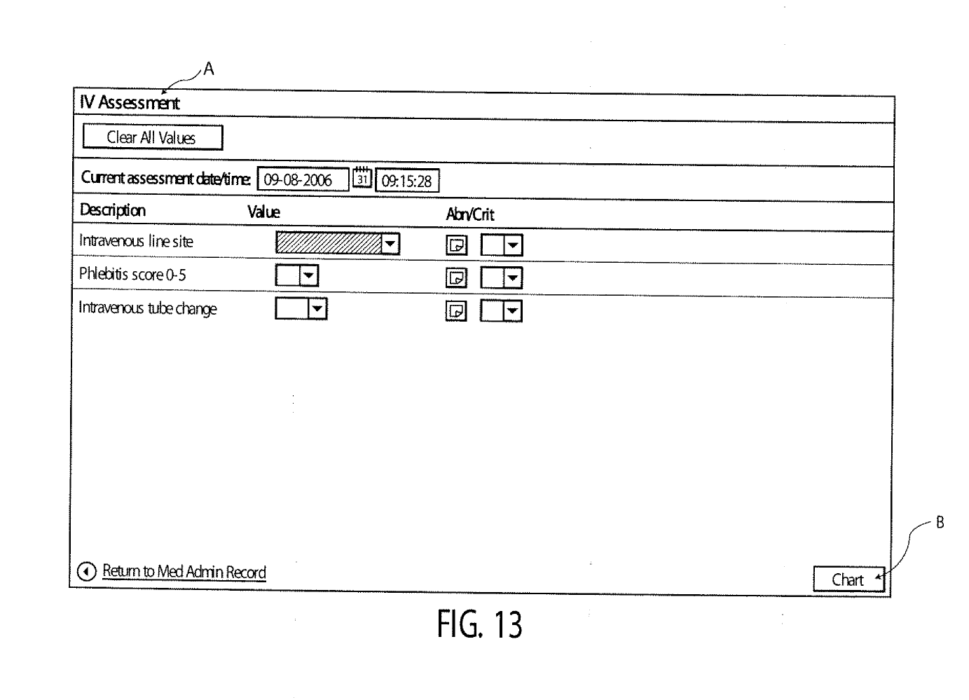

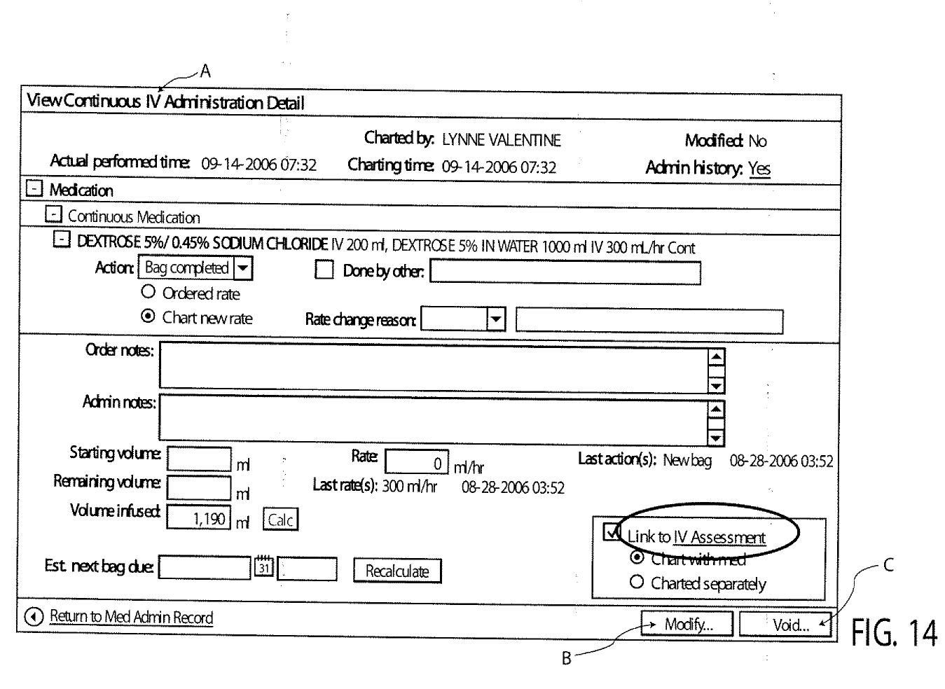

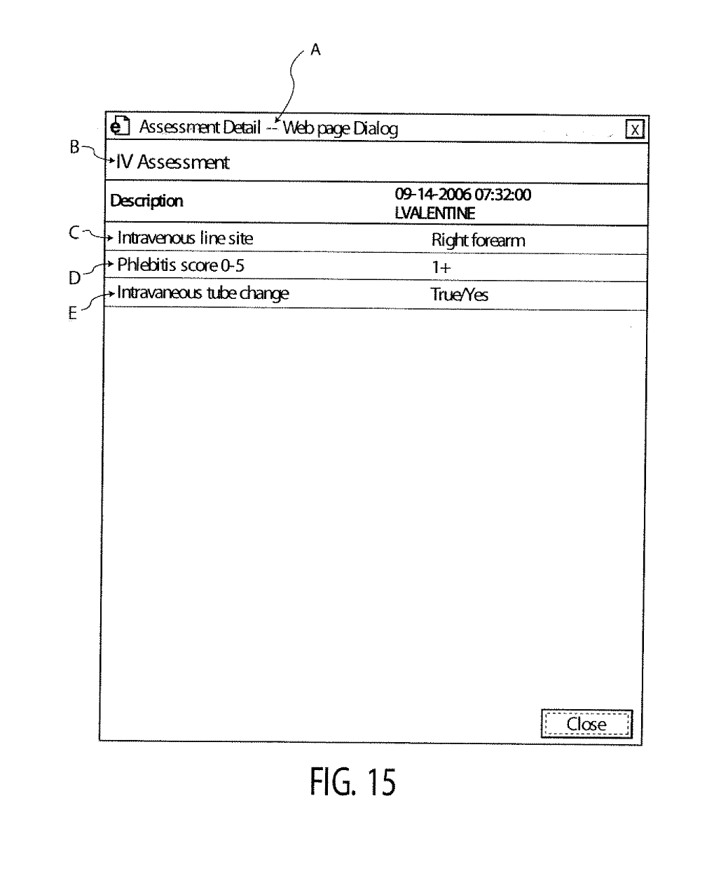

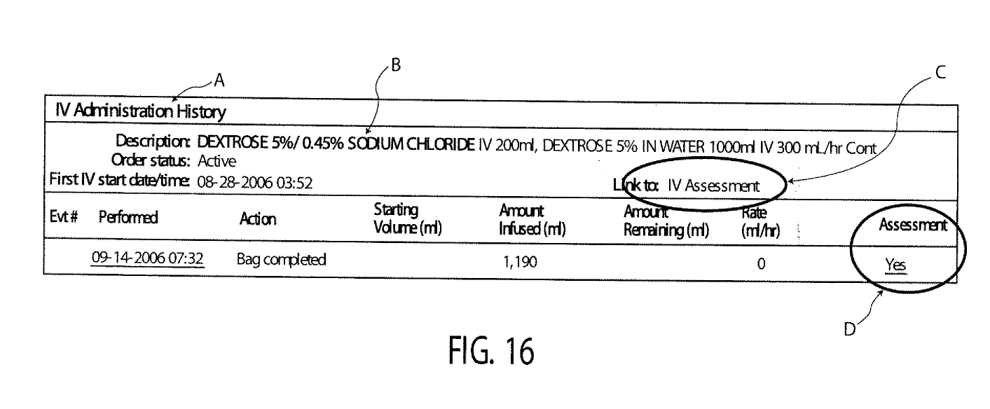

When charting an administration for a medication order associated to a routed drug ID linked with a flowsheet-based assessment for the exemplary IV assessment, a nurse is presented with a Continuous IV administration detail” (arrow A) display image depicted by FIG. 12. The nurse interacts with the display image to chart the administration of the ordered medication (arrow B). The FIG. 12 display image includes a field that identifies a link to an assessment record, i.e., a flowsheet (arrow C). In the example highlighted, the order by routed drug ID, DEXTROSE 5%/0.45% SODIUM CHLORIDE (arrow D), has a linked IV assessment, further qualifying that the IV assessment should be charted with the administration of the bag of solution (arrow E). The display image allows the nurse to document that assessment was charted separately in a case where the IV Assessment is already documented but same assessment is not linked to the medication administration. A navigation button “Chart” also is shown in the lower right of the display image (arrow F). Upon nurse activation of the Chart button within the FIG. 12 display image, an “IV Assessment” display image (arrow A) displays the assessment details, as depicted by FIG. 13. The FIG. 13 assessment detail display image allows to the nurse to document the assessment charting by activating a “Chart” button or field identified by arrow B. Both the FIG. 12 and FIG. 13 display images allow for inputs that return the user to the medical administration record.

Where an assessment has already been completed, and linked as depicted by the “Link to IV Assessment” field of the FIG. 12 display image (identified by arrow E), there is a link between the medication administration record for the order and the exemplary IV Assessment. Hence viewing a record of a medication administration automatically includes an identification of the flowsheet (assessment), which is accessed or hyperlinked if activated. A display image or window representative of this linking, or hyperlinking, is depicted by the continuous IV administration detail (arrow A) display image of FIG. 14. The FIG. 14 display image includes fields in the lower right to allow the nurse to modify (arrow B) or void (arrow C) the medication administration details. FIG. 15 is an exemplary hyperlinked “Assessment Detail-Web Page Dialog” (arrow A) display image of the flowsheet, and individual observations connected with the exemplary IV Assessment (arrow B) charted previously. The particular patient medical parameters associated are identified as intravenous line site (arrow C), phlebitis score 0-5 (arrow D) and intravenous tube change (arrow E). FIG. 16 depicts an “IV Administrative History” display image (arrow A), presenting a view of the administration history for the Dextrose 5%/0.45% SODIUM CHLORIDE (arrow B) with the IV assessment linked (arrow C) to administration, indicated by the “yes” designation in the display image (arrow D). Connecting an observation with a routed drug.

Connecting an Observation to a Routed Drug ID

Where an assessment is defined by entering an “O” in an opt field (arrow D) provided by the FIG. 11 “assessment selection” display image, the assessment comprises a single observation. An “Observation Editing” display image (arrow A) is presented when a user accesses the single observation record, as depicted by FIG. 17. The exemplary example shown in FIG. 17 allows that nurse to chart observations for PAINSCALE (arrow B) when accessed through the medication administration function. An included display field (arrow C) identifies and allows selection of any of a list of valid values representing what was observed.

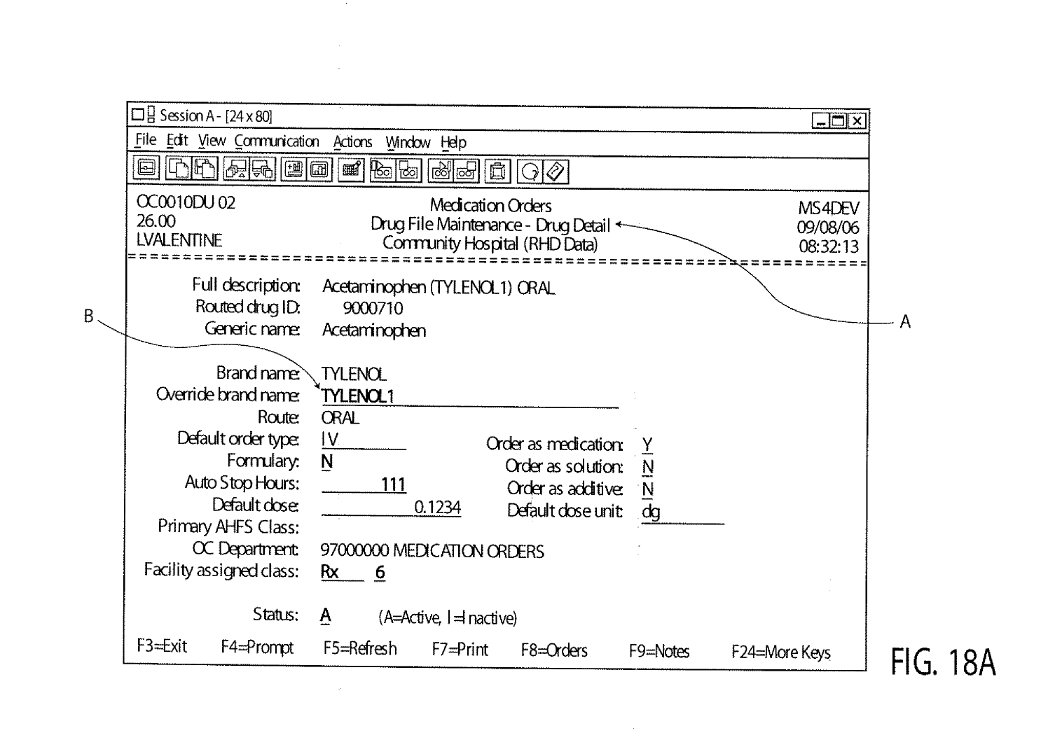

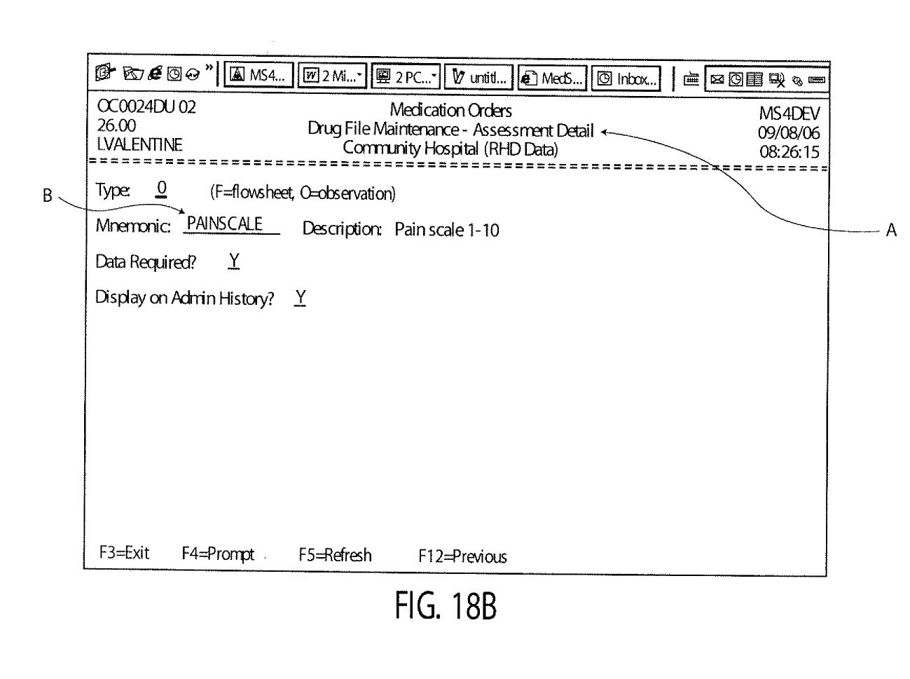

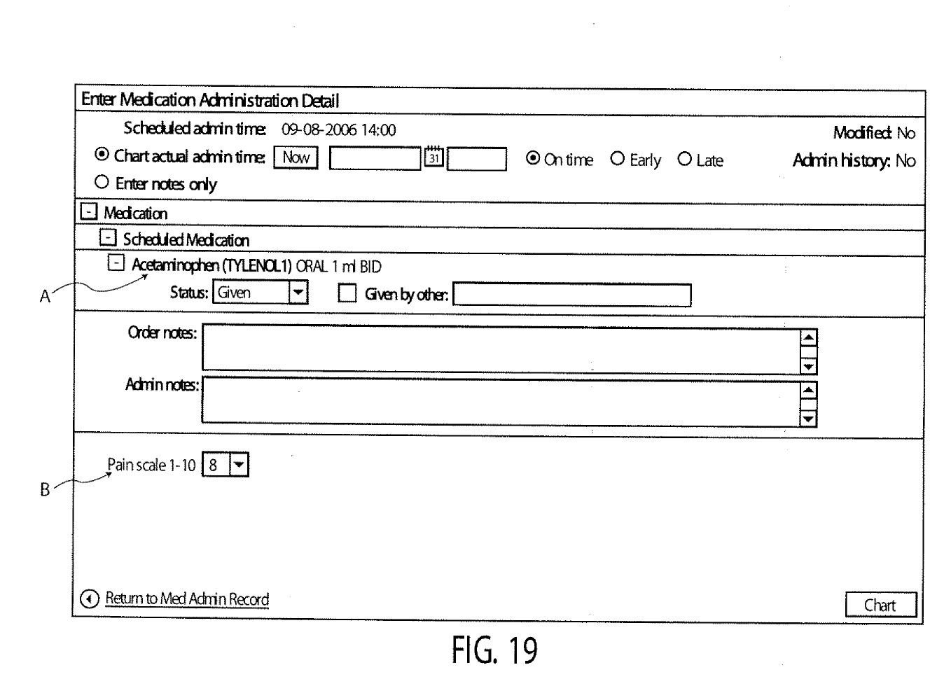

The same process described above for linking a flowsheet assessment to an order by routed drug ID is followed to link a single observation assessment at a medication administration. FIG. 18a depicts an exemplary “drug detail” display image (arrow A) for a medication Tylenol1 (arrow B), routed orally. The FIG. 18a display image is the equivalent in function to the FIG. 8 display image wherein Dextrose 5%/0.45% SODIUM CHLORIDE was ordered and the IV assessment flowsheet linked to administration by the system thereby. An “assessment detail” display image (arrow A) depicted by FIG. 18b presents the single observation: PAINSCALE (arrow B), for the single observation assessment chosen by use of the FIG. 18a display image. Collecting the linked observations while charting medication administration When entering or charting a medication administration that includes a link to a single observation assessment for painscale, “Enter Medication Administration Detail” display image of FIG. 19 is presented for the Tylenol1 example (arrow A). The FIG. 19 display image includes the fields entered when charting the patient medical parameter for the PAINSCALE (arrow B). In a pain scale of 1-10, the FIG. 19 display image shows an “8,” as charted by the nurse or other medical practitioner executing the administration. The FIG. 19 display image field maintains the painscale observation consistently between the medication administration record and assessment applications (by the hyperlinking). Since the file maintenance for this observation in the drug master file field Data Required? is set to Y, this data value is specified by the user, i.e., nurse, when presented with the display image.

Impact of Linked Observations on Medication Administration History Display

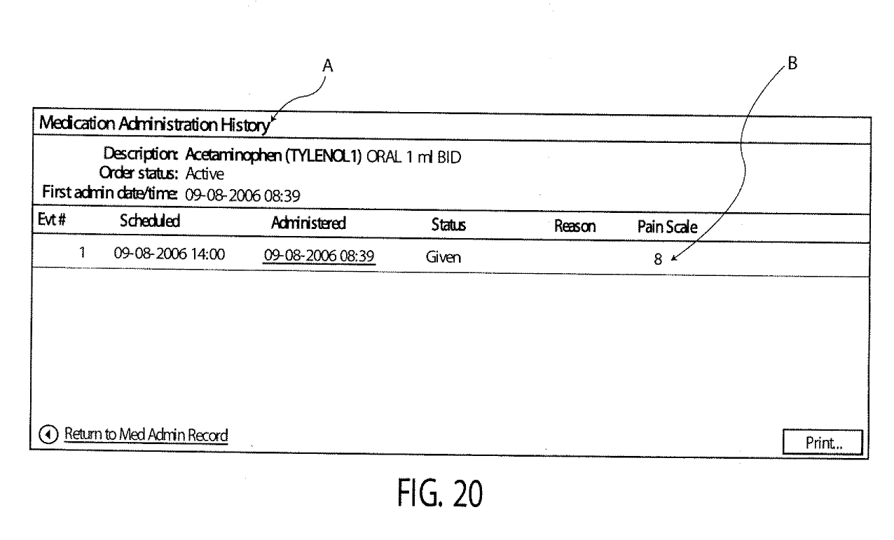

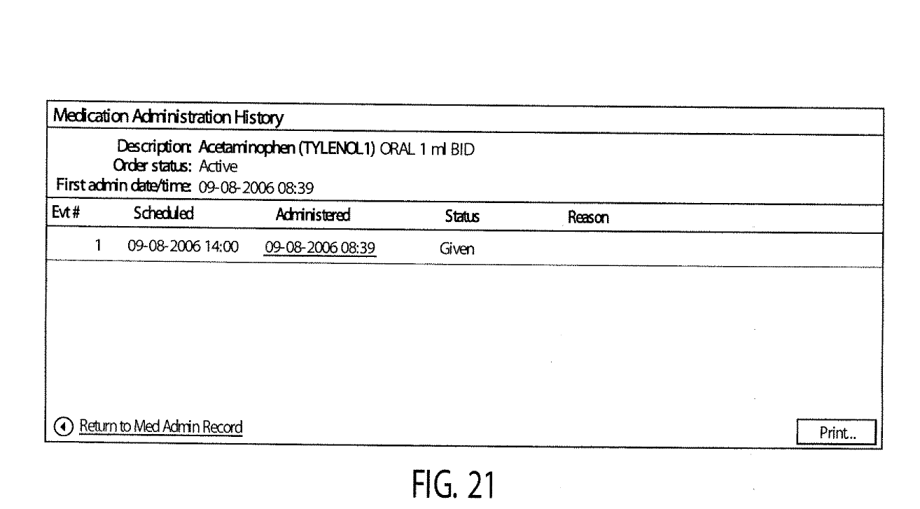

In the drug master file, it was also indicated whether the single observation assessment should be presented on the Administration History display image. The system automatically presents a “Medication Administration History” (arrow A) display image depicted by FIG. 20, where a user defined the assessment by activating the “Display on Admin History?” field in the display image of FIG. 10. This function is set by inputting a Y (yes) as shown (the painscale included as per arrow B). But where the “Display on Admin History?” has been set to N (no), the system presents a medication administration history display image as depicted by FIG. 21, with no painscale indicated.

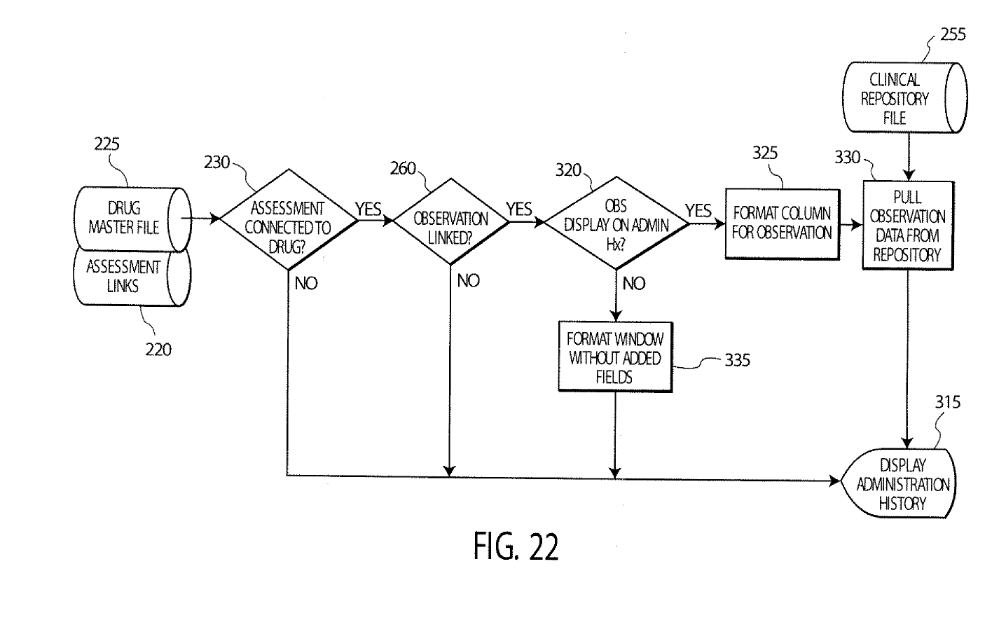

Detailed system operation for linking single observation assessment records is now explained with respect to a system flow diagram of FIG. 22. For operation in association with drug master file (225), assessment links file (220), decision diamond (230) and decision diamond (260), the reader is directed to the operation described above with respect to FIG. 2, for flowsheet-type assessment operation. Where the system determines at a function represented by decision diamond (260) that no observation is linked, system flow passes to a “display administration history” function. The display administration history function displays the administration history by a display function represented by functional block (315). Where the system determines (decision diamond (260)) that a single observation is linked to an assessment, system flow passes to a function represented by decision diamond (320). Decision diamond (320) represents that the system determines whether an observation is linked, whereby the system displays or highlights the link in administration history and medication administration display images. If linked, system flow progresses to a function represented by functional block (325). Functional block (325) formats administration history and medication administration display image to indicate the linked “observation.”

System flow proceeds to an observation data access function represented by functional block (330). The observation data access function accesses the linked observation data from its repository. The repository is represented in the figure by indicator (255), already described above with respect to FIG. 2. Where the determination at the system flow represented by decision diamond (320) finds that the administration history display image is not shown, system flow advances to a function represented by functional block (335). The function formats the display image or window without fields that are representative of a linked observation. System flow-advances for both the function of block (335) and the function of block (330) to the display administration history function (block 315).

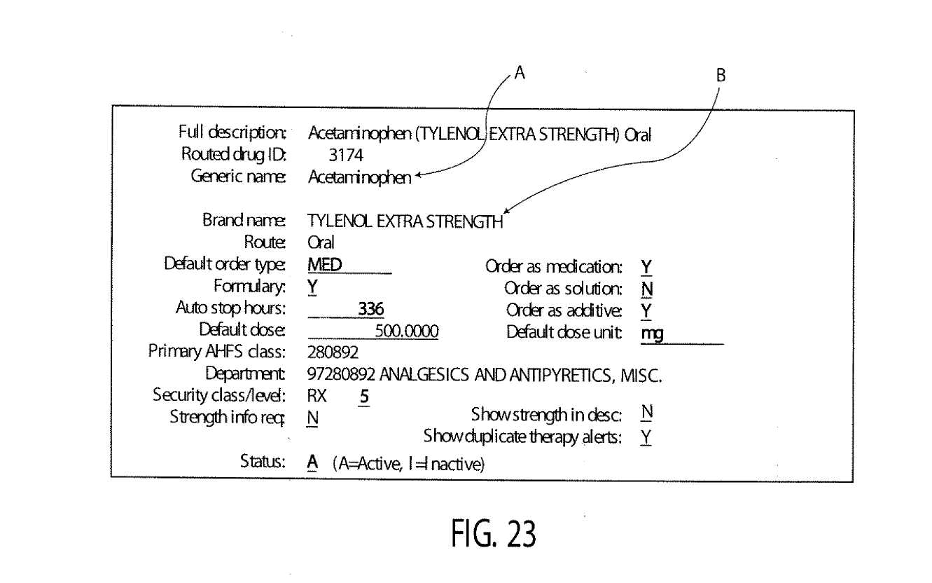

The system adds value by linking a flowsheet in a flowsheet-type assessment, and an observation in an observation-type assessment, or both, with a routed drug ID in the medication administration windows accessed by the nurse when charting an administration for the medication. A display image depicted by FIG. 23 identifies a routed drug ID #3174 (arrow A) for acetaminophen in a form of Tylenol extra strength (arrow B), routed for oral administration. The routed Drug ID is one of several identifiers defined by the system to assist in evaluating the ‘level’ at which the medication is identified (by med name and route). In a preferred system embodiment, this is the second highest level for which a medication can be identified. This medication at the routed level may be either generic or brand name.

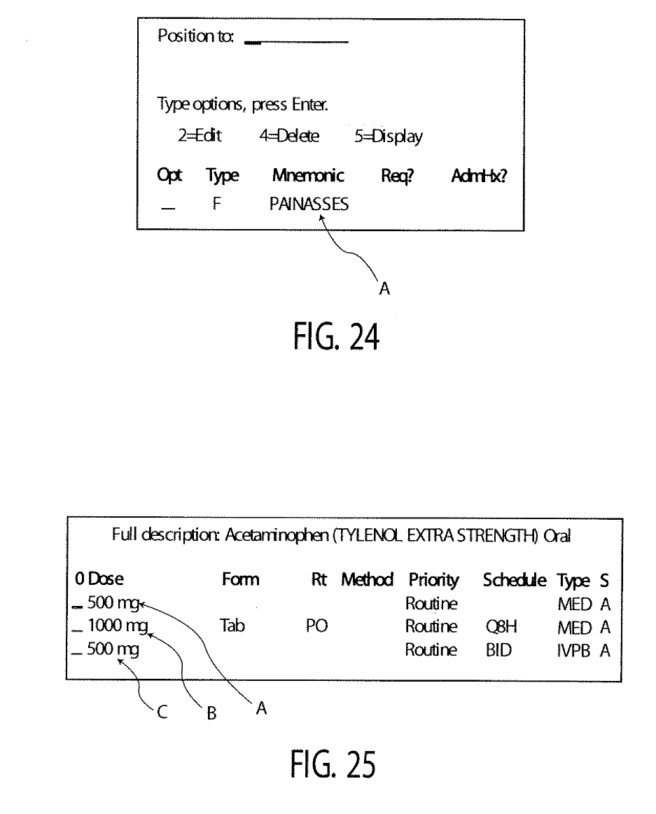

By a single keystroke input by interaction with a display image of FIG. 9, the user links an observation, a flowsheet or both in association with this Routed Drug ID (level). The system operation that links the observations and flowsheets in association with a routed drug ID is now explained in further detail in association with FIG. 24-31. FIG. 24 is a display image that is a portion of an “assessment selection” display image (discussed above with FIG. 11), which identifies an PAINASSES observation (arrow A) instead of the IVASSESS depicted in FIG. 11. The specific observation is included with an exemplary pain assessment flowsheet. FIG. 25 depicts a display image presenting three orders that have been created for Acetaminophen, designated by arrows A, B and C in the figure. Known prior art system associate observations, or sets of observations to the medication orders themselves; the known systems typically fail to associate or link by a routed drug ID, at the system level of operation in contrast to system 5. So, by associating or linking a flowsheet (or observation with a the routed drug ID), the system enhances medication management workflow, or nursing workflow by saving time in not having to perform the additional association for each medication order.

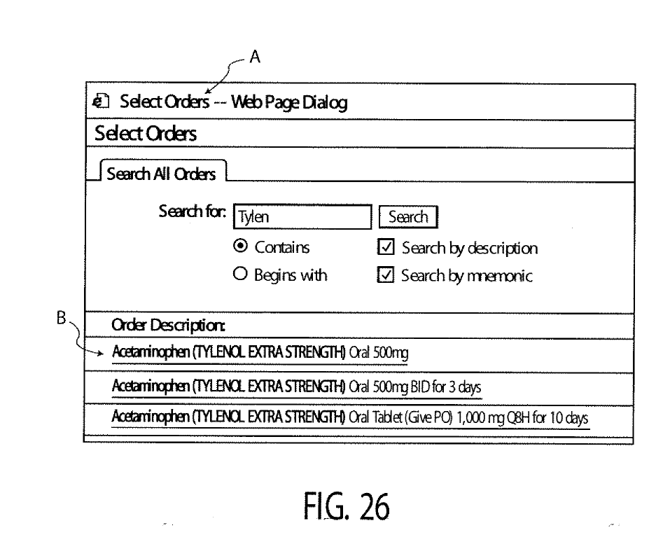

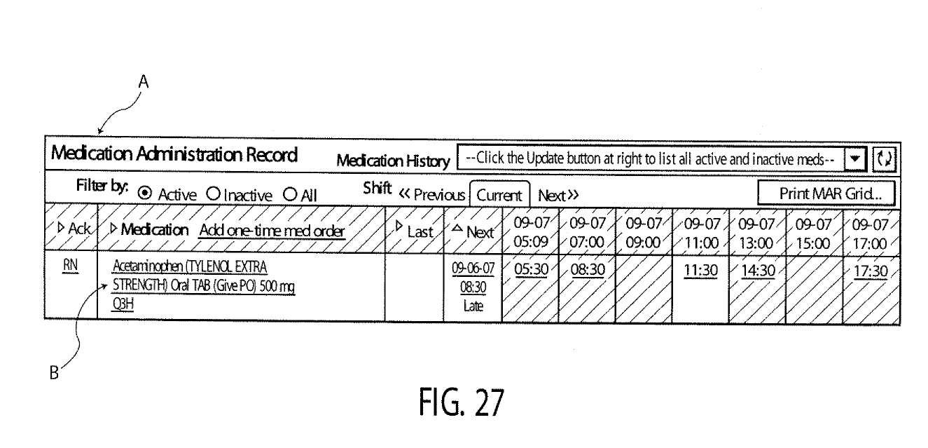

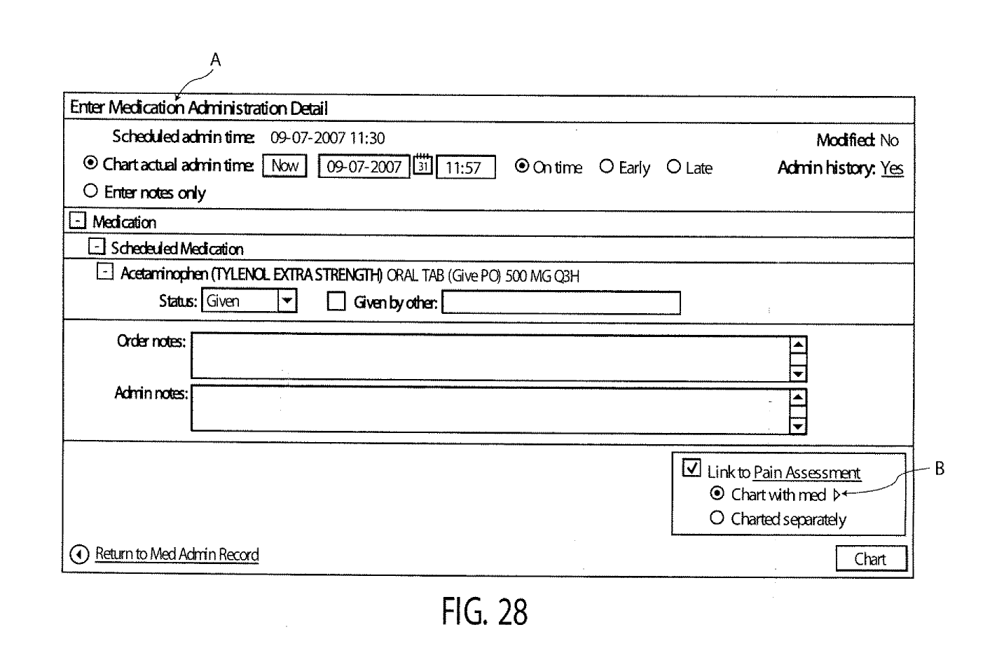

When a physician wants to order Acetaminophen, the system presents him/her with a “Select Orders-Web Dialog Page” display image depicted by FIG. 26 (arrow A). The physician can interactively select whichever order most closely matches what she/he had in mind, and can modify the order as needed, for example, the 500 mg acetaminophen highlighted by arrow B. A display image depicted by FIG. 27 provides for nurse review of a Medication Administration Record (arrow A). The exemplary FIG. 27 display image identifies for the nurse slated for medication administration that the physician has ordered 500 mg to be given by mouth every 3 hours (arrow B). The nurse charts that he/she has administered the medication by use of a “Enter Medication Administration Detail” display image depicted in FIG. 28 (arrow A). The reader should note that in the display image depicted, the nurse is provided with an ability to chart a Pain Assessment at the same time as charting that the medication was given. The reason the system displays “Link to Pain Assessment” (arrow B) in FIG. 28 as activated is because the flowsheet was associated or linked to the medication by the routed drug ID (at the routed drug ID operational level). Hence, any order for Acetaminophen the physician might have placed would display for the nurse the ability to chart a pain assessment.

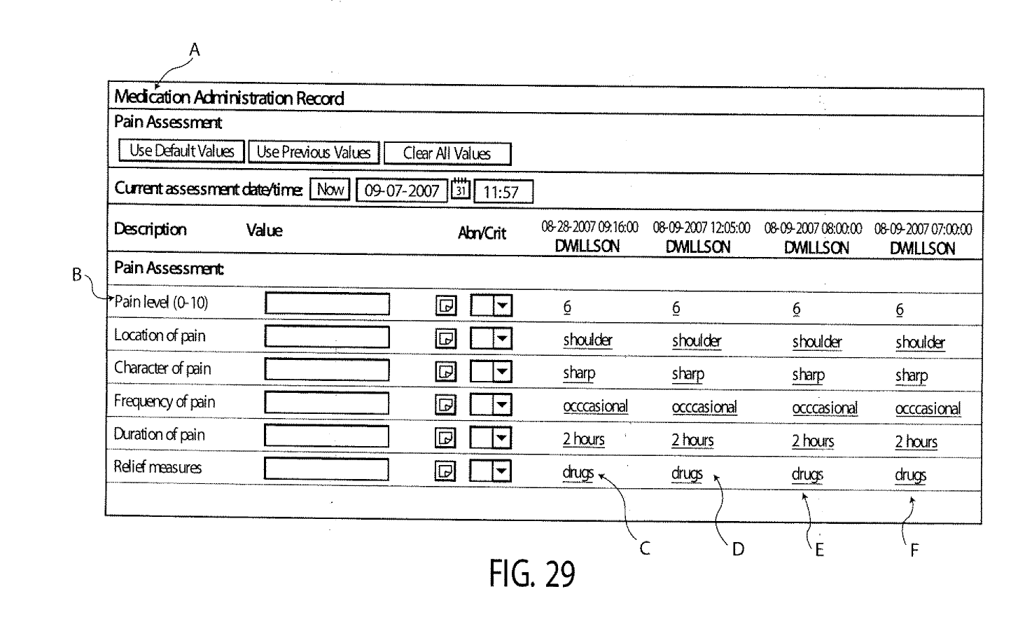

If the association or linking was created at the medication order level, as is the case with prior art medication administration systems, the physician could have placed an order that the facility could “forget” to associate to a pain assessment. The nurse would not be prompted to do this assessment, and of course the patient would not be provided a high standard of care. But with the inventive system operation, if there had been an observation associated with the routed drug ID, the system would present a display image such as “medication administration record” display image depicted in FIG. 29 (arrow A), including a data input field as shown for the specific observation (e.g., the pain level itself).

The nurse has a choice of charting the pain level, charting the pain level and a full assessment, or charting a full assessment. If the nurse decides to document the full pain assessment at the same time as charting the medication, the FIG. 29 display screen is presented in response to the nurse clicking the chart button on the FIG. 28 display image. The nurse can thereby view the last 4 most recently entered pain assessments, designated by arrows C, D, E and F, and modify using the display screen. The reader should note that “Pain level” is a single observation or patient medical parameter.

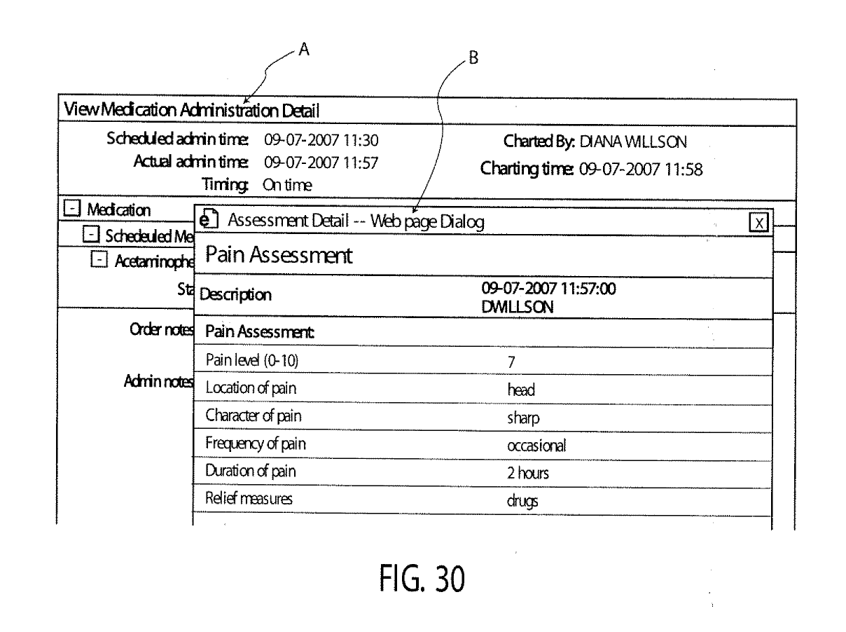

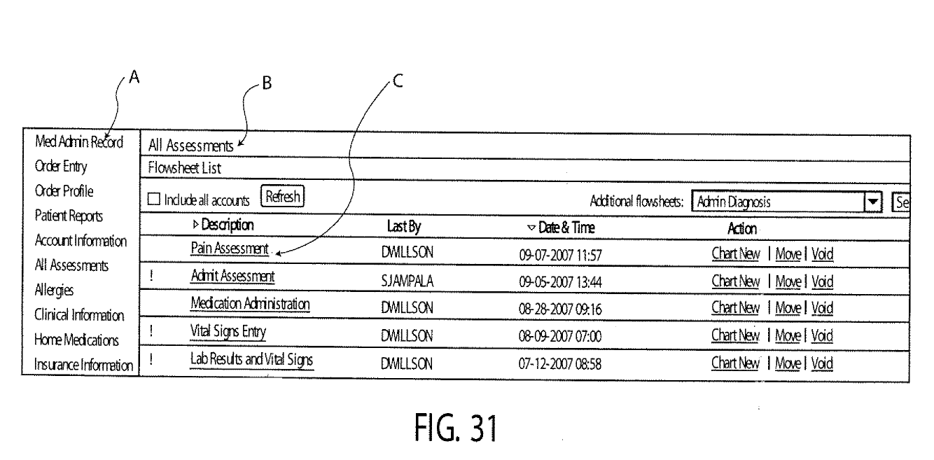

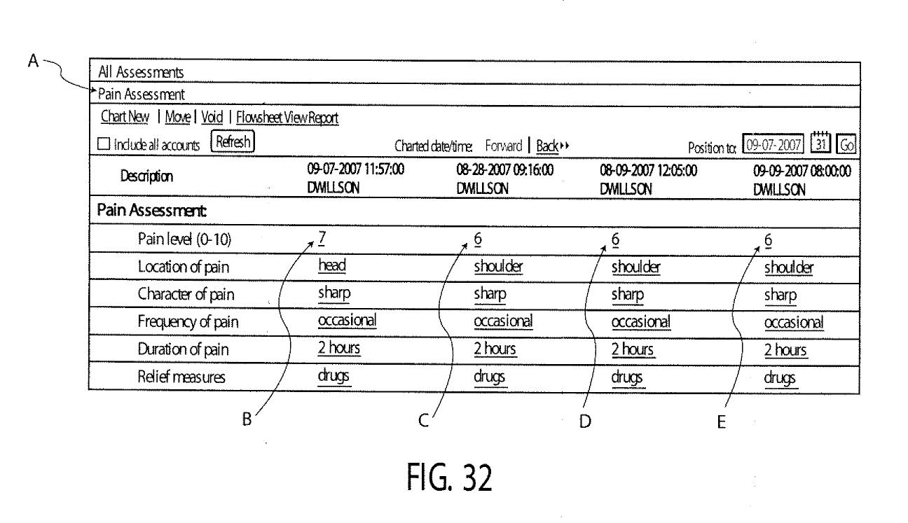

After charting a full pain assessment, this specific assessment is linked to the specific medication administration. The result of the linking is presented by the “View Administration Detail” display image (arrow A) depicted by FIG. 30 and including the “Assessment Detail-Web Dialog” (arrow B). Again, because of the linking in association with the routed drug ID, the charted pain assessment is viewable to healthcare clinicians using the system for review. A “Medication Administration Record) display image (arrow A) depicted in FIG. 31 highlights this feature, whereby a navigator function (option) identified as “All Assessment” (described above and highlighted by arrow B in FIG. 31) presents a list of flowsheets, for example, a “pain assessment” flowsheet highlighted by arrow C. And where the clinician clicks or activates the “Pain Assessment”, the system generates a display image as depicted by FIG. 32 (arrow A), by which pain assessments for that patient are presented, including the four assessments (arrows B-E) charted during the medication administration.

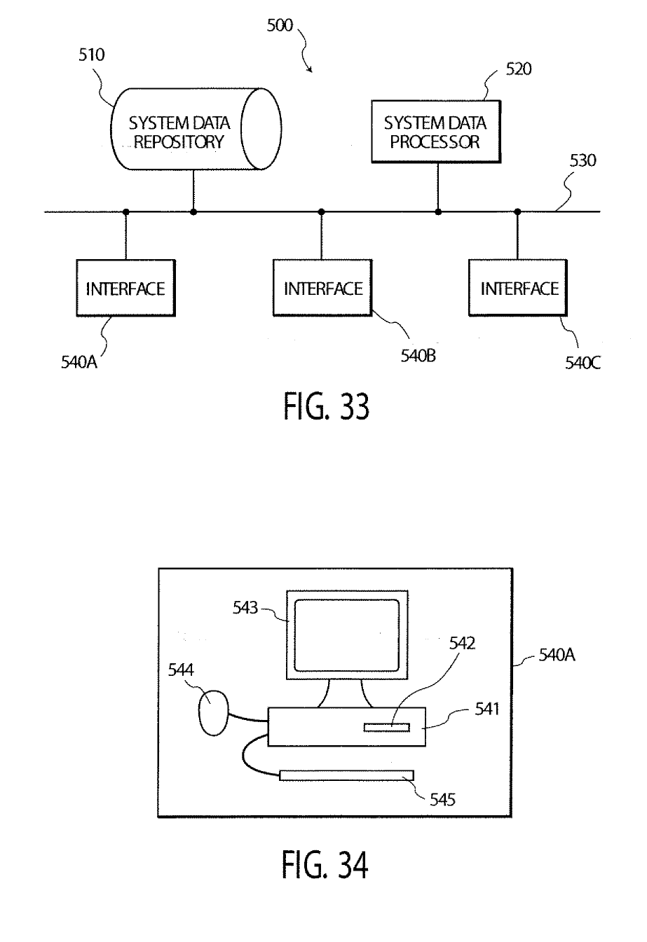

Another embodiment of the invention is described with respect to a system for processing patient medical information (500) as presented in FIG. 33. System (500) includes at least one repository of system information, or system data repository (510). System data repository (510) is maintained by the system to store and provide access to predetermined patient medical parameters comprising observation data, and identifiers identifying a medication and a method of administration for the medication for intended system operation. In more detail, system data repository (510) represents system repository files such as observation master file (205), observation group master file (210), flowsheet master file (215), drug master file (220), assessment links (file, 220), medication administration file (250), and clinical repository file (255), without limitation.

A system data processor (520) is shown connected to system data repository (510) though a system bus (530), for example, an Ethernet bus. System bus (530) as shown is representative of any device or apparatus for connecting one or more system elements, including wireless connecting, connection via communicating networks, internet, etc., without limitation. System data processor (520) using the system information stored in the system data repository (510) to link one or more predetermined patient medical parameters to be acquired for a particular patient in association with the at least one identifier for a particular medication for administration to the patient, and method of administration of the medication (associated with the identifier). Preferably, the patient medical parameters are stored as predetermined single observation assessment records and flowsheet-type observation records of the patient medical parameters.

User interfaces (540A, 540B, 540C) are shown connected via system bus (530) and therefore system data processor (520) and system data repository (510) to represent user access to, and operation with system (500) by use of the user interfaces. User interfaces (540A, 540B, 540C) are implemented as any computer system, or computer workstation, laptop computer and other known computer devices, without limitation, connectable to system (500), or system bus (530) by known connection devices and apparatus. An exemplary user interface 540(A) representative of user interfaces (540A, 540B, 540C) is shown in FIG. 34. User interface (540A) includes a processing unit (541) with a processor, memory and other computer components that implement a general purpose processing system or execute a computer program product (not shown explicitly). The computer program product comprises a compact storage medium such as a compact disc that is read by the processing unit by a disc drive (542).

The computer program product may be stored on hard disk drives (542), in processing unit RAM or other memory (not explicitly shown), in storage attached to system data processor (520) or in system data repository (510). Monitor (543), mouse (544) and keyboard (545) are coupled to the processing unit (441), to provide user interaction with the system. User interface (540A) provides the user with various system interactive display images. The various display images include without limitation supporting a user in documenting information concerning administration of particular medication, and observed patient medical parameters to be acquired or displayed before, during or after the medication administration to the patient. In more detail, by such user interfaces, system (500) enables users create and view an assessment records comprising said at least one predetermined patient medical parameter of patient to be acquired in support of the documentation of said administration of the particular medication to the patient.

The same user interfaces, i.e., user interface (540A), are used by users, e.g., physicians, accessing the system to order a medication by a particular route for administration in association with the medication's system identifier. This user is provided with display images to allow him/her to define the assessments in a form of a single observation and flowsheet-type assessment record, that are linked to medication administration records comprising the system information. For that matter, the user interfaces are used by users accessing the system to administer a medication order for a patient in association with a medication identifier, such as nurses. When a nurse accesses system information to chart administration of such ordered medication, the nurse is presented with a display image identifying that the order includes an assessment. The nurse accesses the assessment information through the user interface, and inputs data comprising one or more patient medical parameters as required by the predetermined assessment.

While it is apparent that the invention herein disclosed is well calculated to fulfill the objects stated above, numerous modifications and embodiments are devisable by those skilled in the art and it is intended that the appended claims cover such modifications and embodiments as fall within the true spirit and scope of the present invention. For that matter, the invention has been described herein with reference to particular exemplary embodiments. Certain alterations and modifications may be apparent to those skilled in the art, without departing from the scope of the invention.
What is claimed is:

1. A system for processing patient medical information, comprising:
at least one repository of information associating at least one predetermined patient medical parameter to be acquired with at least one identifier identifying a medication and a method of administration of said medication;
a data processor for using said information to link the at least one predetermined patient medical parameter to be acquired for a particular patient in association with the at least one identifier identifying a particular medication for administration to said patient, and a method of administration of said particular medication associated with said at least one identifier; and
a user interface for providing a display image including data supporting a user in documenting information concerning administration of said particular medication to said patient and enabling the user to view and access an assessment record comprising said at least one predetermined patient medical parameter of said patient to be acquired in support of said documentation of said administration of said particular medication to said patient.

2. A system according to claim 1, including that said display image enables a user to access data comprising previously acquired values for said at least one predetermined patient medical parameter of said patient associated with a medication administration history of said patient.

3. A system according to claim 1, including that said display image enables a user to access said data indicating said at least one predetermined patient medical parameter of said patient to be acquired prior to said administration of said particular medication to said patient and in response to user command.

4. A system according to claim 3, including that said user command comprises a medication order in association with the at least one identifier.

5. A system according to claim 1, including that said display image enables a user to access said data indicating said at least one predetermined patient medical parameter of said patient to be acquired at least one of, (a) following and (b) during, said administration of said particular medication to said patient and in response to user command.

6. A system according to claim 1, wherein said at least one predetermined patient medical parameter may comprise one of a single observation record, and a multiple observation record containing a single and a group of patient medical parameters, respectively.

7. A system for processing patient medical information, comprising:
at least one repository of information associating a predetermined set of patient medical parameters to be acquired with at least one identifier identifying a medication and a method of administration of said medication;
a data processor for using said information to identify a predetermined particular set of patient medical parameters to be acquired for a patient in response to receiving at least one identifier identifying a particular medication for administration to said patient and a method of administration of said particular medication; and
a user interface for providing a display image including data documenting information concerning administration of said particular medication to said patient and enabling a user to access data comprising values of said predetermined particular set of patient medical parameters of said patient acquired in response to said administration of said particular medication to said patient.

8. A system according to claim 7, including that said display image enables a user to access data comprising previously acquired values of a set of predetermined patient medical parameters of said patient associated with a medication administration history of said patient.

9. A system according to claim 7, wherein said display image enables a user to access data comprising previously acquired values of said set of predetermined patient medical parameters via a user selectable element representing an Internet compatible hyperlink.

10. A system according to claim 7, wherein said information associates a sequence of acquisitions of parameters with a set of predetermined patient medical parameters to be acquired, and wherein said user interface provides a display image indicating said sequence in which said particular set of predetermined patient medical parameters are to be acquired in response to said administration of said particular medication to said patient.

11. A system according to claim 10, wherein said display image indicating said sequence in which said particular set of predetermined patient medical parameters are to be acquired is provided at least one of, (a) during, (b) prior to and (c) after, said administration of said particular medication to said patient.

12. A system according to claim 7, wherein said data processor receives said at least one identifier identifying said particular medication for administration to said patient and said method of administration of said particular medication in response to a physician initiating an electronic order for said medication to be administered to said particular treatment.

13. A system according to claim 7, wherein said user interface provides a display image including parameter values of said particular set of predetermined patient medical parameters, said parameter values being presented in the chronological order of acquisition.

14. A system according to claim 13, wherein said display image including parameter values of said predetermined set of predetermined patient medical parameters includes additional patient medical parameters acquired during non-medication administration monitoring activity.

15. A system according to claim 7, wherein said user interface provides a display image including said particular set of predetermined patient medical parameters during the process of ordering the medication.

16. A system according to claim 15, wherein said user interface enables a user to edit said particular set of predetermined patient medical parameters during the process of ordering the medication to provide a customized set of patient parameters specific to the medication order and to the patient.

17. A system according to claim 7, wherein said data processor uses said information to identify a plurality of particular sets of predetermined patient medical parameters to be acquired for a patient in response to receiving said at least one identifier identifying said particular medication for administration to said patient and said method of administration of said particular medication.

18. A system according to claim 7, wherein said sets of predetermined patient medical parameters comprises a single patient medical parameter.

19. A system for processing patient medical information, comprising:
at least one repository of information associating a predetermined set of patient medical parameters to be acquired with at least one identifier identifying a medication and a method of administration of said medication;
a treatment order processor for processing user entered data in generating a record representing an order for administration of a particular medication to a particular patient and a method of administration of said particular medication;
a data processor for using said information to identify a predetermined particular set of patient parameters to be acquired for a patient in response to receiving at least one identifier identifying said particular medication for administration to said particular patient and said method of administration of said particular medication; and
a user interface for providing a display image including said predetermined particular set of patient parameters in response to a user command entered via a display image supporting review of said order for administration of said particular medication to said particular patient.

20. A method of medication administration for application in a medical information system, the method comprising steps of:
with a user interface, configuring system medication identifiers for use in ordering patient medications with a specific route for administering the medication such that predetermined assessment data, comprising at least one specified patient parameter, and relating to the administering by said route are linked and presented upon access to a medication administration record for charting and administering;
ordering a patient medication of the patient medications, wherein an access to the predetermined assessment data relating to administering the patient medication by said route are immediately identified, and any system required observations for the assessment are presented by one or more display images, as predetermined by the step of configuring;
administering one of the ordered patient medications, wherein upon access to the medication administration record associated with the one ordered patient medication, a link to predetermined assessment data is immediately identifiable, and a record of said predetermined assessment data is accessible by hyperlink.

21. A computer program product, comprising:
a tangible storage medium readable by a processing circuit and storing instructions for execution by the processing circuit for performing a method as set forth in claim 20.
